(19) United States
(12) Patent Application Publication
(10) Pub. No.: US 2025/0321548 A1
(43) Pub. Date: Oct. 16, 2025

(54) REINFORCEMENT LEARNING FOR SUBSTRATE PROCESSING FACILITY

(71) Applicant: Applied Materials, Inc., Santa Clara, CA (US)

(72) Inventors: David Everton Norman, Bountiful, UT (US); Harel Moshe Yedidsion, Pflugerville, TX (US); Prafulla Nath Dawadi, San Mateo, CA (US)

(21) Appl. No.: 18/782,510

(22) Filed: Jul. 24, 2024

Related U.S. Application Data
(60) Provisional application No. 63/633,566, filed on Apr. 12, 2024.

(51) Int. Cl. G05B 13/02

(52) U.S. Cl. CPC G05B 13/0265

(57) ABSTRACT

A method includes identifying current state data associated with a substrate processing facility including one or more higher-yield tools and one or more lower-yield tools that have a lower yield than the one or more higher-yield tools. The method further includes providing the current state data as input to a trained reinforcement learning agent. The method further includes receiving, from the trained reinforcement learning agent, output associated with parameters. The method further includes causing, based on the parameters, maximizing of lot processing on the one or more higher-yield tools while meeting one or more threshold production values.

### RELATED APPLICATION

This application claims benefit of U.S. Provisional Application No. 63/633,566, filed Apr. 12, 2024, the entire contents of which are hereby incorporated by reference in their entirety.

### TECHNICAL FIELD

The present disclosure relates to reinforcement learning, and in particular to reinforcement learning for substrate processing facility.

### BACKGROUND

Products are produced by performing one or more manufacturing processes using manufacturing equipment. For example, substrate processing equipment is used to process substrates.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In an aspect of the disclosure, a method includes: identifying current state data associated with a substrate processing facility comprising one or more higher-yield tools and one or more lower-yield tools that have a lower yield than the one or more higher-yield tools; providing the current state data as input to a trained reinforcement learning agent; receiving, from the trained reinforcement learning agent, output associated with parameters; and causing, based on the parameters, maximizing of lot processing on the one or more higher-yield tools while meeting one or more threshold production values.

In another aspect of the disclosure, a method includes: identifying state data associated with a substrate processing facility comprising one or more higher-yield tools and one or more lower-yield tools that have a lower yield than the one or more higher-yield tools; identifying reward data associated with maximizing lot processing on the one or more higher-yield tools while meeting one or more threshold production values; and training a reinforcement learning agent using the state data and the reward data to generate a trained reinforcement learning agent. The trained reinforcement learning agent is to output parameters to maximize the lot processing on the one or more higher-yield tools while meeting the one or more threshold production values.

In another aspect of the disclosure, a non-transitory computer readable medium having instructions stored thereon, which, when executed by a processing device, cause the processing device perform operations including: identifying current state data associated with a substrate processing facility comprising one or more higher-yield tools and one or more lower-yield tools that have a lower yield than the one or more higher-yield tools; providing the current state data as input to a trained reinforcement learning agent; receiving, from the trained reinforcement learning agent, output associated with parameters; and causing, based on the parameters, maximizing of lot processing on the one or more higher-yield tools while meeting one or more threshold production values.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to certain embodiments.

FIG. 2A-D illustrates example systems associated with performing reinforcement learning, according to certain embodiments.

FIGS. 3A-B are graphs associated with reinforcement learning, according to certain embodiments.

FIGS. 4A-B are flow diagrams of methods associated with reinforcement learning for substrate processing facilities, according to certain embodiments.

FIG. 5 is a block diagram illustrating a computer system, according to certain embodiments.

### DETAILED DESCRIPTION

Described herein are technologies directed to reinforcement learning for substrate processing facilities (e.g., reinforcement learning for yield improvement using dispatching, using reinforcement learning for substrate dispatching management at a substrate processing facility, by tuning dispatching, yield improvement using deep reinforcement learning for dispatch rule tuning, reinforcement learning for dispatching parameters and ranking, etc.).

Manufacturing equipment of a substrate processing facility (e.g., substrate fabrication facility) can include multiple substrate processing tools where each tool can have one or more processing chambers. A processing chamber can have multiple sub-systems operating during each substrate manufacturing process (e.g., the deposition process, the etch process, the polishing process, etc.). A sub-system can include a set of sensors and controls related with an operational parameter of the processing chamber. An operational parameter can be a temperature, a flow rate, a pressure, and so forth. In an example, a pressure sub-system can include one or more sensors measuring the gas flow, the chamber pressure, the control valve angle, the foreline (vacuum line between pumps) pressure, the pump speed, and so forth. Accordingly, the processing chamber can include a pressure sub-system, a flow sub-system, a temperature subsystem, and so forth.

A processing chamber can perform a manufacturing process according to a process recipe. A process recipe defines a particular set of operations to be performed for the substrate during the process and can include one or more settings associated with each operation. A process recipe can include a table of recipe settings including a set of inputs or recipe parameters and processes that are manually entered by a user (e.g., process engineer) to achieve a set of target properties (e.g., on-substrate characteristics, thickness, uniformity, etc.), also referred to as a set of goals. For example, a deposition process recipe can include a temperature setting for the processing chamber, a pressure setting for the processing chamber, a flow rate setting for a precursor for a material included in the film deposited on the substrate surface, etc. Accordingly, the thickness of each film layer, the depth of each etch, and so forth, can be correlated to these processing chamber settings.

Conventionally, one or more of stations, components, systems, tools, sub-systems, processes, etc. of a substrate processing facility are selected to maximize the probability of on-time delivery (e.g., producing a threshold amount of substrates that meet a threshold quality within a threshold amount of time).

One or more tools, stations, components, systems, tools, sub-systems, processes, etc. may be of higher yield (e.g., produce more substrates, produces usable chips per substrate which reduces the cost per chip) and others may be lower yield (e.g., produce less substrates, produce less usable chips per substrate which increases the cost per chip).

Conventionally, there is a difficult tradeoff between on-time delivery and processing lots of substrates on high-yield tools. Conventionally, to have on-time delivery, the lots of substrates are processed as quickly as possible on all tools (e.g., higher-yield tools and lower-yield tools). Conventionally to process lots on higher-yield tools includes waiting to process lots to see if a high-yield tool will become available, which decreases the probability of the lots being ready for on-time delivery.

The present disclosure solves these and other shortcomings of conventional systems. The present disclosure may provide a way to automatically manage tradeoff between on-time delivery and processing lots on high-yield tools. The present disclosure may train and use a reinforcement learning agent (e.g., reinforcement learning model) to maximize lot processing on higher-yield tools while providing on-time delivery.

A processing device may identify state data (e.g., current state data, historical state data, perturbed state data, etc.) associated with a substrate processing facility. The state data may include state of components of the substrate processing facility (e.g., location of lots of substrates, settings of equipment, preventative maintenance of equipment, etc.).

The substrate processing facility may include higher-yield tools and lower-yield tools that have a lower yield than the higher-yield tools. Higher-yield tools may produce more substrates and/or may produce more components (e.g., chips, semiconductors) per substrate (e.g., in less time) than lower-yield tools.

The processing device may identify reward data. The reward data may be associated with maximizing lot processing on the higher-yield tools (e.g., produce more substrates of the lots in the higher-yield tools) while meeting threshold production values (e.g., providing on-time delivery).

The processing device may train a reinforcement learning agent (e.g., reinforcement learning machine learning model) using the state data and the reward data to generate a trained reinforcement learning agent (e.g., configured to output parameters to maximize the lot processing on the one or more higher-yield tools while meeting the one or more threshold production values).

A processing device may identify current state data associated with a substrate processing facility that includes comprising higher-yield tools and lower-yield tools. The processing device may provide the current state data as input to a trained reinforcement learning agent and may receive, from the trained reinforcement learning agent, output associated with parameters. The processing device may cause, based on the parameters, maximizing of lot processing on the one or more higher-yield tools while meeting one or more threshold production values (e.g., on-time delivery).

The parameters may include one or more of: a maximum waiting lot amount (e.g., how many lots of substrates are to be waiting) before lot processing via the one or more lower-yield tools; a maximum lot wait time (e.g., how long a lot of substrates is to wait) before lot processing via the one or more lower-yield tools; per-part wait time (e.g., how long to wait for a part of a higher-yield tool) before lot processing via the one or more lower-yield tools; per-process wait time (e.g., how long to wait for a higher-yield process of a higher-yield tool) before lot processing via the one or more lower-yield tools; and/or maximum lot wait time for each work-in-progress (WIP) lot (e.g., how long a lot of substrates is to wait that is being processed).

Aspects of the present disclosure result in technological advantages compared to conventional solutions. In some embodiments, the present disclosure results in increased usage of high-yield tools while providing on-time delivery compared to conventional solutions. This causes the present disclosure to produce more substrates and/or components (e.g., chips, semiconductors) per substrate than which reduces the cost per substrate and/or component and reduces materials and energy used compared to conventional solutions. This also allows the present disclosure to also meet other key performance indicators such as on-time delivery and total lot processing while having increased usage of high-yield tools compared to conventional solutions. The present disclosure may provide on-time delivery while using high-yield tools in such a way that uses less energy consumption (e.g., battery consumption), bandwidth, and/or processor overhead compared to conventional solutions. This may be because the present disclosure avoids the errors of conventional solutions and in so doing avoids the increased energy consumption, bandwidth, and processor overhead used by conventional solutions to perform corrective actions.

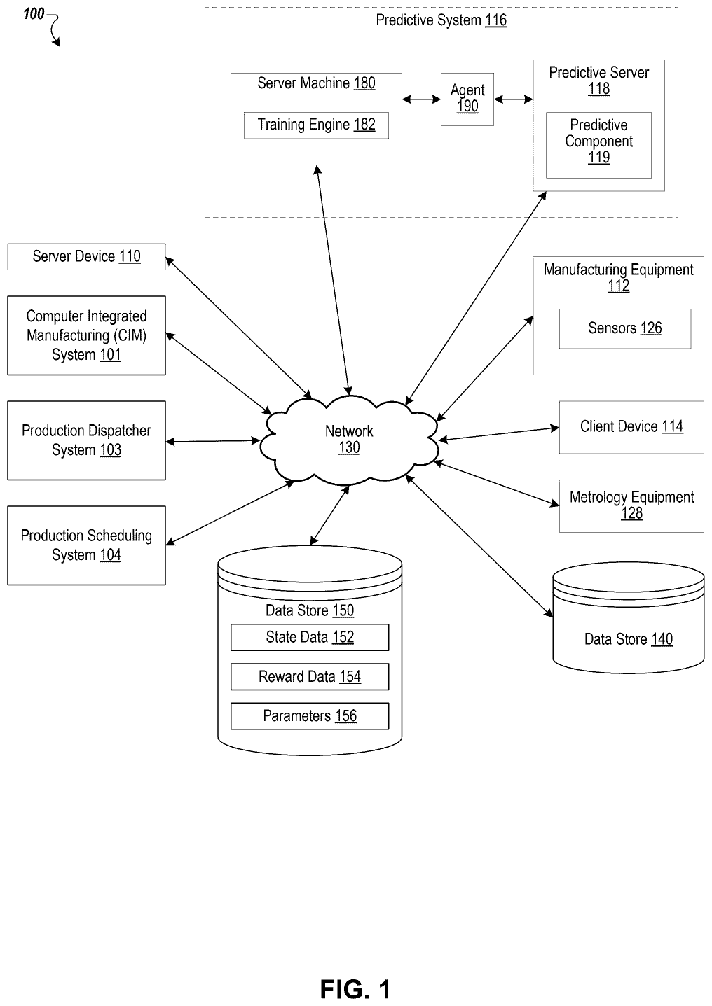

FIG. 1 is a block diagram illustrating a production environment 100 (e.g., substrate processing facility, substrate fabrication facility), according to aspects of the present disclosure. A production environment 100 can include multiple systems, such as, and not limited to, a production dispatcher system 103, production scheduling system 104, manufacturing equipment 112 (e.g., manufacturing tools, automated devices, etc.), a client device 114, a predictive system 116 (e.g., to generate predictive data such as parameters to make dispatching decisions, to provide model or agent adaptation, to use a knowledge base, etc.), and one or more computer integrated manufacturing (CIM) systems 101. Examples of a production environment 100 can include, and are not limited to, a manufacturing plant, a fulfillment center, etc. For brevity and simplicity, a substrate processing facility is used as an example of a production environment 100. One or more components of FIG. 1 may be used to provide the components and/or perform the methods of the present disclosure.

In some embodiments, production environment 100 can be a substrate processing facility. In such embodiments, manufacturing equipment 112 (e.g., higher-yield tools and lower-yield tools) can perform multiple different operations related to the fabrication of substrates, such as, for example, semiconductor wafers. For example, manufacturing equipment 112 can be substrate processing tools that perform one or more of cutting operations, cleaning operations, deposition operations, etching operations, testing operations, and so forth. Aspects of the present disclosure are described with regard to fabrication of semiconductor substrates in a semiconductor manufacturing environment. However, it should be noted that embodiments of the present disclosure can be applied to other production environments 100 configured to fabricate or otherwise process lots different from semiconductor substrates. A lot can refer to a set of substrates.

In some embodiments, the manufacturing equipment 112 (e.g., cluster tool) is part of a substrate processing system (e.g., integrated processing system). The manufacturing equipment 112 includes one or more of a controller, an enclosure system (e.g., substrate carrier, front opening unified pod (FOUP), auto teach FOUP, process kit enclosure system, substrate enclosure system, cassette, etc.), a side storage pod (SSP), an aligner device (e.g., aligner chamber), a factory interface (e.g., equipment front end module (EFEM)), a load lock, a transfer chamber, one or more processing chambers (e.g., multi-slot processing chambers), a robot arm (e.g., disposed in the transfer chamber, disposed in the front interface, etc.), and/or the like. The enclosure system, SSP, and load lock mount to the factory interface and a robot arm disposed in the factory interface is to transfer content (e.g., substrates, process kit rings, carriers, validation wafer, etc.) between the enclosure system, SSP, load lock, and factory interface. The aligner device is disposed in the factory interface to align the content. The load lock and the processing chambers mount to the transfer chamber and a robot arm disposed in the transfer chamber is to transfer content (e.g., substrates, process kit rings, carriers, validation wafer, etc.) between the load lock, the processing chambers, and the transfer chamber. In some embodiments, the manufacturing equipment 112 includes components of substrate processing systems. In some embodiments, data store 140 and/or data store 150 includes sensor data including parameters of processes performed by components of the manufacturing equipment 112 (e.g., radio frequency (RF) generation, lifting, etching, heating, cooling, transferring, processing, flowing, cleaning, etc.).

The manufacturing equipment 112 can include sensors 126 configured to capture data for a substrate being processed at the manufacturing equipment 112. In some embodiments, the manufacturing equipment 112 and sensors 126 can be part of a sensor system that includes a sensor server (e.g., field service server (FSS) at a manufacturing facility) and sensor identifier reader (e.g., front opening unified pod (FOUP) radio frequency identification (RFID) reader for sensor system). In some embodiments, manufacturing equipment 112 can include, or be operationally coupled to, metrology equipment 128 that includes a metrology server (e.g., a metrology database, metrology folders, etc.) and metrology identifier reader (e.g., FOUP RFID reader for metrology system).

In some embodiments, the sensors 126 provide sensor data (e.g., sensor values, such as historical sensor values and current sensor values) associated with manufacturing equipment 112. In some embodiments, the sensors 126 include one or more of an RF sensor, a lift sensor, an imaging sensor (e.g., camera, image capturing device, etc.), a pressure sensor, a temperature sensor, a flow rate sensor, a spectroscopy sensor, and/or the like. In some embodiments, the sensor data used for equipment health and/or product health (e.g., product quality). In some embodiments, the sensor data is received over a period of time. In some embodiments, sensors 126 provide sensor data such as values of one or more of image data, leak rate, temperature, pressure, flow rate (e.g., gas flow), pumping efficiency, spacing (SP), High Frequency Radio Frequency (HFRF), electrical current, power, voltage, and/or the like. In some embodiments, the sensor data and/or performance data includes sensor data from one or more of sensors 126.

In some embodiments, the sensor data is processed by the client device 114 and/or by the server device 110. In some embodiments, processing of the sensor data includes generating features. In some embodiments, the features are a portion of the sensor data (e.g., transfer operations, processing operations, etc.), processed sensor data (e.g., processed transfer data, processed processing data), pattern in the sensor data (e.g., repetition of transfers, processing, etc.), or a combination of values from the sensor data (e.g., ratio of transfer time to processing time, etc.). In some embodiments, the sensor data includes features that are used by the server device 110 and/or client device 114 to perform one or more of the methods of the present disclosure.

In some embodiments, the metrology equipment 128 (e.g., imaging equipment, spectroscopy equipment, ellipsometry equipment, etc.) is used to determine metrology data (e.g., inspection data, image data, spectroscopy data, ellipsometry data, material compositional, optical, or structural data, etc.) corresponding to substrates produced by the manufacturing equipment 112 (e.g., substrate processing equipment). In some examples, after the manufacturing equipment 112 processes substrates, the metrology equipment 128 is used to inspect portions (e.g., layers) of the substrates. In some embodiments, the metrology equipment 128 performs scanning acoustic microscopy (SAM), ultrasonic inspection, x-ray inspection, and/or computed tomography (CT) inspection. In some examples, after the manufacturing equipment 112 deposits one or more layers on a substrate, the metrology equipment 128 is used to determine quality of the processed substrate (e.g., thicknesses of the layers, uniformity of the layers, interlayer spacing of the layer, and/or the like). In some embodiments, the metrology equipment 128 includes an image capturing device (e.g., SAM equipment, ultrasonic equipment, x-ray equipment, CT equipment, and/or the like). In some embodiments, data store 140 stores performance data (e.g., metrology data) from metrology equipment 128.

Manufacturing equipment 112 can produce products, such as substrates, following a recipe or performing runs over a period of time. Manufacturing equipment 112 can include a process chamber. Manufacturing equipment 112 can perform a process for a substrate (e.g., a semiconductor wafer, etc.) at the process chamber. Examples of substrate processes include a deposition process to deposit one or more layers of film on a surface of the substrate, an etch process to form a pattern on the surface of the substrate, etc. Manufacturing equipment 112 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc.

In some embodiments, sensors 126 provide sensor data (e.g., sensor values, features, trace data) associated with manufacturing equipment 112 (e.g., associated with producing, by manufacturing equipment 112, corresponding products, such as wafers). The manufacturing equipment 112 can produce products following a recipe or by performing runs over a period of time. Sensor data received over a period of time (e.g., corresponding to at least part of a recipe or run) can be referred to as trace data (e.g., historical trace data, current trace data, etc.) received from different sensors 126 over time. Sensor data can include a value of one or more of temperature (e.g., heater temperature), spacing (SP), pressure, high frequency radio frequency (HFRF), voltage of electrostatic chuck (ESC), electrical current, material flow, power, voltage, etc. Sensor data can be associated with or indicative of manufacturing parameters such as hardware parameters, such as settings or components (e.g., size, type, etc.) of the manufacturing equipment 112, or process parameters of the manufacturing equipment 112. The sensor data can be provided while the manufacturing equipment 112 is performing manufacturing processes (e.g., equipment readings when processing products). The sensor data can be different for each substrate.

The CIM systems 101, production dispatcher system 103, production scheduling system 104, manufacturing equipment 112, client device 114, predictive system 116, and/or data stores 140, 150 can be coupled to each other via network 130. Network 130 can include one or more wide area networks (WANs), local area networks (LANs), wired networks (e.g., Ethernet network), wireless networks (e.g., an 802.11 network or a Wi-Fi network), cellular networks (e.g., a Long-Term Evolution (LTE) network), routers, hubs, switches, server computers, cloud computing networks, and/or a combination thereof. The CIM system 101, production dispatcher system 103, production scheduling system 104, and predictive system 116 can be individually hosted or hosted in any combination together by any type of machine including server computers, gateway computers, desktop computers, laptop computers, tablet computers, notebook computers, PDAs (personal digital assistants), mobile communication devices, cell phones, smart phones, hand-held computers, or similar computing devices. In some embodiments, predictive system 116 is part of a server that is hosted on a machine.

Data stores 140, 150 can be a memory (e.g., random access memory), a drive (e.g., a hard drive, a flash drive), a database system, or another type of component or device capable of storing data. Data stores 140, 150 can include multiple storage components (e.g., multiple drives or multiple databases) that can span multiple computing devices (e.g., multiple server computers).

Data store 140 can store data associated with processing a substrate at manufacturing equipment 112. For example, data store 140 can store data collected by sensors 126 at manufacturing equipment 112 before, during, or after a substrate process (referred to as process data). Process data can refer to historical process data (e.g., process data generated for a prior substrate processed at the fabrication facility) and/or current process data (e.g., process data generated for a current substrate processed at the fabrication facility). Data store can also store spectral data or non-spectral data associated with a portion of a substrate processed at manufacturing equipment 112. Spectral data can include historical spectral data and/or current spectral data.

Data store 140 can also store contextual data associated with one or more substrates processed at the fabrication facility. Contextual data can include a recipe name, recipe step number, preventive maintenance indicator, operator, etc. Contextual data can refer to historical contextual data (e.g., contextual data associated with a prior process performed for a prior substrate) and/or current process data (e.g., contextual data associated with current process or a future process to be performed for a prior substrate). The contextual data can further include identify sensors that are associated with a particular sub-system of a process chamber.

Data store 140 can also store task data. Task data can include one or more sets of operations to be performed for the substrate during a deposition process and can include one or more settings associated with each operation. For example, task data for a deposition process can include a temperature setting for a process chamber, a pressure setting for a process chamber, a flow rate setting for a precursor for a material of a film deposited on a substrate, etc. In another example, task data can include controlling pressure at a defined pressure point for the flow value. Task data can refer to historical task data (e.g., task data associated with a prior process performed for a prior substrate) and/or current task data (e.g., task data associated with current process or a future process to be performed for a substrate).

In some embodiments, data store 140 can be configured to store data that is not accessible to a user of the fabrication facility. For example, process data, spectral data, contextual data, etc. obtained for a substrate being processed at the fabrication facility is not accessible to a user (e.g., an operator) of the fabrication facility. In some embodiments, all data stored at data store 140 can be inaccessible by the user of the fabrication facility. In other or similar embodiments, a portion of data stored at data store 140 can be inaccessible by the user while another portion of data stored at data store 140 can be accessible by the user. In some embodiments, one or more portions of data stored at data store 140 can be encrypted using an encryption mechanism that is unknown to the user (e.g., data is encrypted using a private encryption key). In other or similar embodiments, data store 140 can include multiple data stores where data that is inaccessible to the user is stored in one or more first data stores and data that is accessible to the user is stored in one or more second data stores.

Data store 150 can include state data 152, reward data 154, and parameters 156. In some embodiments, data store 150 includes dispatching rules, scheduler, and/or user data. In some embodiments, parameters include dispatching rules, scheduler, ranking orders, etc. Dispatching rules can be logic that can be executed by the production dispatcher system 103. Scheduler can be logic that can be executed by the production scheduling system 104. In some embodiments, dispatching rules, scheduler, reward data 154, and/or parameters can be user (e.g., industrial engineer, process engineer, system engineer, etc.) defined. In some embodiments, dispatching rules, scheduler, reward data 154, and/or parameters can be generated or modified by agent 190 and/or predictive component 119. In some embodiments, dispatching rules, scheduler, reward data 154, and/or parameters can determine which substrate or substrate lot a process chamber (or other tool) is to process. Examples of dispatching rules, scheduler, reward data 154, and/or parameters can include, and are not limited to, select the highest priority substrate to work on next, select a substrate that uses the same set up which the tool is currently configured for, package items when a purchase order is complete, ship items when packaging is complete, etc. In an illustrative example, dispatching rules, scheduler, reward data 154, and/or parameters can sort a list of available substrates or substrate lots, the sorted list being indicative of which substrate or lot a process chamber(s) should work on next. The individual dispatching rules, scheduler, reward data 154, and/or parameters can be associated with a large number of data processes to implement the corresponding dispatching rules, scheduler, reward data 154, and/or parameters. Examples of data processes can include, and are not limited to import data, compress data, index data, filter data, perform a mathematical function on data, etc.

Parameters 156 can include one or more of dispatching parameters, scheduling parameters, ranking orders (dispatching ranking orders, scheduling ranking orders, etc.), and/or the like. Parameters 156 can be referred to as factors (e.g., dispatching factors, scheduling factors, etc.). A parameter can be any value or criterion (which can be referred to as dispatching and/or scheduling settings) used to determine or configure how a dispatching rule and/or scheduler operates. For example, a parameters (e.g., dispatching parameter) can include threshold values for bucket boundaries, values indicative of the relative importance of two ranking factors (e.g., a parameter that controls the relative preference of running lots on higher-yield tools versus running lots as quickly as possible to meet on-time delivery requirements), batching parameters (e.g., the maximum time to wait for a full lot or batch to process), bottleneck tool indicators (e.g., which process chambers can cause a bottleneck in production, such as, for example, a process chamber preforming lithography processing), WIP thresholds (e.g., a high WIP threshold, a low WIP threshold, etc.), critically late thresholds (e.g., whether a lot is past its time constraint), overload thresholds (e.g., the amount of work to be queued in front of a tool for the tool to be considered overloaded), etc. Buckets can refer to a sorting scheme for certain factors (e.g., critical ratio values, queue time limits, move targets). Bucket boundaries are threshold values used to define buckets. For example, a first bucket can be defined as [0, p₁], the next bucket can be defined as [p₁, p₂], and so forth. In an illustrative example, a first bucket for queue time limits can include a lower threshold limit of 10 minutes and an upper threshold limit of less than 12 minutes, a second bucket for queue time limits can include a lower threshold limit of 12 minutes and an upper threshold limit of less than 14 minutes, objective function weight and soft constraints as used by an optimization system, and so forth.

Parameters 156 can include ranking orders (e.g., dispatching ranking orders, scheduling ranking orders, ranking factors, dispatching settings, scheduling settings, etc.) used to order a set of lots or substrates in a dispatching order and/or scheduling order. The ranking order can be applied (e.g., by a rule) in a specified order to rank a set of lots or substrates. For example, the ranking order can first sort candidate lots based on queue time constraints, then sort based on lot priority, then sort based on feeding downstream bottlenecks, then based on critical ratio buckets, then tie break using arrival time.

State data 152 can include a state of manufacturing equipment 112 (e.g., an operating temperature, an operating pressure, a number of substrates being processed at the manufacturing equipment, a number of substrates in a manufacturing equipment queue at a particular instance of time, current service life, setup data, a set of operations that include individual processes performed at one or more manufacturing facilities of a production environment, etc.). State data 152 can be generated by manufacturing equipment 112 during operation of production environment 100 and stored at data store 150. State data 152 can include one or more of current state data, historical state data, and perturbed state data. Current state data can include data relating to the current state of manufacturing equipment 112 (e.g., current operating temperature, current operating pressure, current number of substrates being processed at the manufacturing equipment, etc.). Historical state data can include data relating to a past state of manufacturing equipment 112 (e.g., past operating temperature at a particular instance of time, past operating pressure at a particular instance of time, past number of substrates being processed at the manufacturing equipment at a particular instance of time, etc.). Perturbed state data can include modified state data. In particular, perturbed state data can include current or historical state data that has had one or more parameters modified or distorted. The one or more parameters can be modified based on user input, a certain percentage, a certain value, randomly modified, etc. For example, perturbed state data can include a past number of substrates being processed at the manufacturing equipment at a particular instance of time reduced or increased by a predetermined value of two substrates. In another example, perturbed state data can include a past number of substrates sets being processed at the manufacturing equipment at a particular instance of time reduced or increased by a random number of sets between, for example, one and ten. In some embodiments, state data 152 can include, or be generated from, the data stored in data store 140. For example, state data 152 can include, or be generated from, sensor data, contextual data, task data, etc.

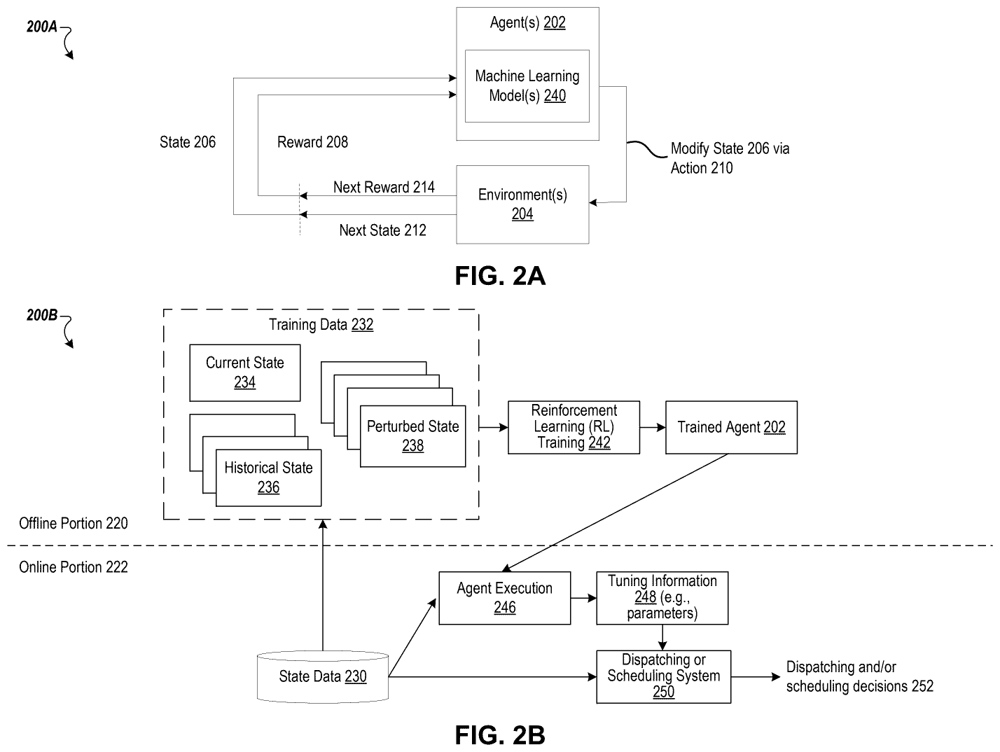

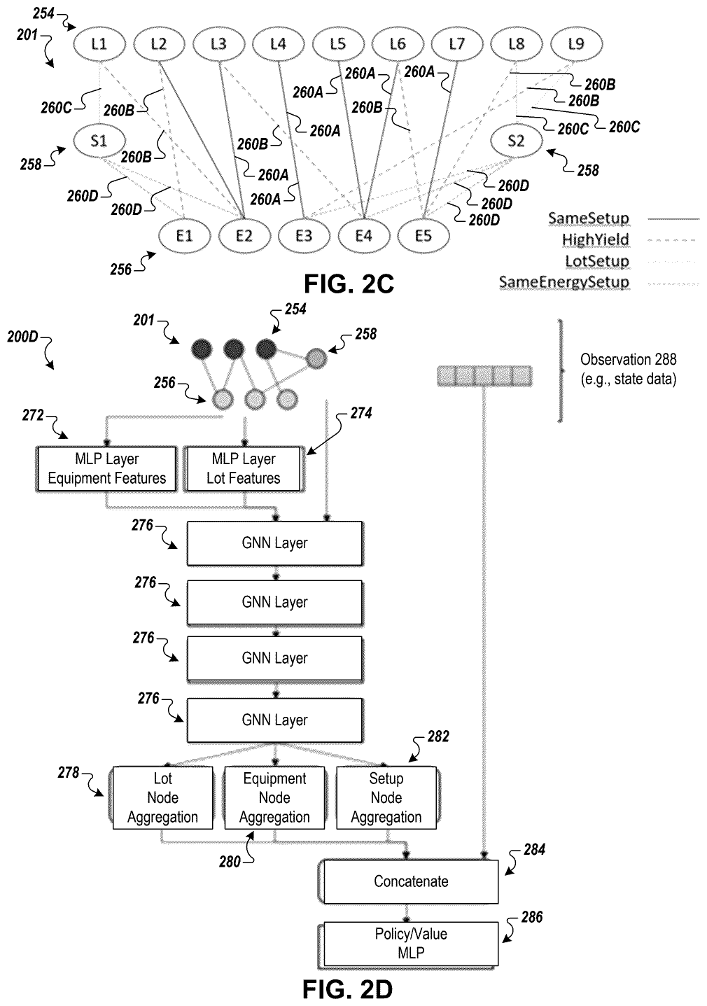

In some embodiments, state data 152 can refer to data relating to the environment state of a simulation environment (e.g., environment 204 of FIG. 2). The environment state data can include manufacturing equipment properties (e.g., operation processing times, queue time constraints, etc.), manufacturing equipment observations (e.g., the number of substrates or lots processing per step, the number of lots processing per stations, etc.), queue time observations (e.g., the number of successful lots processed, the number of lots in violation, the number of lots in process, etc.), capacity observations (e.g., an estimation of the time to complete all the work in progress (WIP)). The environment state features can be normalized to values in [0,1] and concatenated into a single observation vector.

User data can include data provided by a user of production environment 100 (e.g., an operator, a process engineer, industrial engineer, system engineer, etc.). In some embodiments, user data can be provided via client device 114.

A client device 114 can include a computing device such as a personal computer (PC), laptop, mobile phone, smart phone, tablet computer, netbook computer, network-connected television, etc. In some embodiments, client device 114 can provide information to a user (e.g., an operator, an industrial engineer, a process engineer, a system engineer, etc.) of production environment 100 via one or more graphical user interfaces (GUIs).

Examples of CIM systems 101 can include, and are not limited to, a manufacturing execution system (MES), enterprise resource planning (ERP), production planning and control (PPC), computer-aided systems (e.g., design, engineering, manufacturing, processing planning, quality assurance), computer numerical controlled machine tools, direct numerical control machine tools, controllers, etc.

In some embodiments, predictive system 116 includes predictive server 118 and server machine 180. The predictive server 118, server machine 180, and/or server device 110 can each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

Predictive system 116 can train an agent 190 (e.g., software agent, reinforcement learning agent, an intelligent agent, machine learning model, reinforcement learning machine learning model). An agent 190 is a computer program that acts for a user or other program in a relationship of agency. In some embodiments, agent 190 can be trained using reinforcement learning, deep reinforcement learning, etc. Reinforcement learning is a class of algorithms applicable to sequential decision-making tasks. In particular, reinforcement learning is a process in which a software agent learns to make decisions through trial and error.

In some embodiments, training the software agent can include using deep reinforcement learning. Deep reinforcement learning combines artificial neural networks with a framework of reinforcement learning (e.g., learning from trial and error) that helps agents 190 learn how to reach their goals. In particular, deep reinforcement learning unites function approximation and target optimization, mapping states, and actions to the rewards to which they lead. In an embodiment, the Proximal Policy Optimization (PPO) algorithm can be used to train agent 190. The PPO algorithm is a deep reinforcement learning (RL) algorithm which uses a policy gradient method to train a stochastic policy in an on-policy way. The PPO algorithm also utilizes the actor critic method. Details regarding training agent 190 using deep reinforcement learning are described below in FIG. 2.

Deep learning is a class of machine-learning algorithms that use a cascade of multiple layers of nonlinear processing units for feature extraction and transformation. Each successive layer uses the output from the previous layer as input. Deep neural networks can learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. A deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs can be that of the network and can be the number of hidden layers plus one. For recurrent neural networks, in which a signal can propagate through a layer more than once, the CAP depth is potentially unlimited.

Training of a neural network can be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

In some embodiments, training of a neural network can be achieved using reinforcement learning. Reinforcement learning differs from supervised learning in not needing labeled input/output pairs be presented, and in not needing sub-optimal actions to be explicitly corrected. The focus of reinforcement learning can be on finding a balance between exploration of uncharted territory and exploitation of current knowledge. Partially supervised reinforcement algorithms can combine the advantages of supervised and RL algorithms.

Server machine 180 can include a training engine 182. An engine can refer to hardware (e.g., circuitry, dedicated logic, programmable logic, microcode, processing device, etc.), software (such as instructions run on a processing device, a general-purpose computer system, or a dedicated machine), firmware, microcode, or a combination thereof. Training engine 182 can be capable of training one or more software agents 190. Software agent 190 can be created by the training engine 182 using the training data (also referred to herein as a training set) that includes simulation environments, rewards (e.g., reward data 154), actions, states (e.g., observations, state data 152), etc.

To effectuate training, processing logic can input the training dataset(s) into one or more simulation environments. Prior to inputting a first input into the simulation environment, the agent 190 (e.g., software agent, reinforcement learning agent) can be initialized. Processing logic trains the agent 190 based on the actions provided to the simulation environment and the rewards (e.g., reward data 154) and observations (e.g., state data 152) obtained from the simulation environment (based on the simulation state). Processing logic can pause the simulation and the agent 190 processes the obtained observations (e.g., state data 152) and rewards data 154 and selects a new action to input into the simulation. The simulation then resumes and this can be repeatedly performed until the simulations is complete. The agent 190 can be trained on multiple simulations. Once trained, the agent 190 can be applied to current state data 152 of the manufacturing equipment 112, and the agent 190 can generate an output indicative of one or more predictions or inferences (e.g., parameters 156). For example, an output prediction or inference can include one or more parameters 156 (e.g., dispatching parameters, ranking orders, a modification to one or more existing parameters, a modification to one or more existing ranking orders, etc.).

After one or more rounds of training, processing logic can determine whether a stopping criterion has been met. A stopping criterion can be a target level of accuracy, a target number of processed images from the training dataset, a target amount of change to parameters 156 over one or more previous data points, a combination thereof and/or other criteria.

Once one or more trained agents 190 are generated, they can be stored in predictive server 118 as predictive component 119 or as a component of predictive component 119.

As described in detail below, predictive server 118 includes a predictive component 119 that is capable of running trained agent 190 on current state data 152 and providing predicative data indicative of one or more parameters 156 (e.g., dispatching parameters and/or one or more ranking orders).

It should be noted that in some other embodiments, the functions of server machine 180, as well as predictive server 118, can be provided by a fewer number of machines. For example, in some embodiments, server machine 180 and predictive server 118, can be integrated into a single machine.

In general, functions described in one embodiment as being performed by server machine 180 and/or predictive server 118 can also be performed on client device 114. In addition, the functionality attributed to a particular component can be performed by different or multiple components operating together.

In embodiments, a “user” can be represented as a single individual. However, other embodiments of the disclosure encompass a “user” being an entity controlled by a plurality of users and/or an automated source. For example, a set of individual users federated as a group of administrators can be considered a “user.”

The production dispatcher system 103 and/or production scheduling system 104 can make decisions (e.g., dispatching decisions, scheduling decisions) for the production environment 100 (e.g., based on parameters 156 associated with output of a trained agent 190).

A dispatching decision is associated with what action should be performed at a given time in the production environment 100. Dispatching often involves decisions such as whether the start processing a batch, whether to start processing a batch that has fewer substrates than allowed or wait to start the batch until additional substrates are available so a full batch can be started, etc. Examples of dispatching decisions can include, and are not limited to, where a substrate should be processed next in the production environment, which substrate should be picked for an idle piece of equipment in the production environment, and so forth.

A scheduling decision is associated with what actions are to be performed (e.g., multiple dispatching decisions over time, multiple dispatching decisions one after another, etc.). Scheduling decisions may be used to generate a schedule.

In some embodiments, the production dispatcher system 103 and/or production scheduling system 104 can use the predictive data generated by the predictive component 119 (e.g., the dispatching parameters and/or dispatching order) to make a decision (e.g., dispatching decision, scheduling decision). In some embodiments, the production dispatcher system 103 and/or production scheduling system 104 can use one or more rules (e.g., dispatching rules, scheduling rules, scheduler) that are stored in the data store 150 to make a dispatching decision and/or a scheduling decision (e.g., to generate a schedule).

In some embodiments, manufacturing processes can include of hundreds of operations performed by manufacturing equipment 112 (e.g., tools or automated devices) within the production environment 100. In some embodiments, one or more operations can be subjected to a time constraint. A time constraint refers to a particular amount of time after an operation is completed that a subsequent operation is to be completed. For example, after a first material is deposited on a surface of a substrate, a second material is to be deposited on the first material within a particular amount of time after the deposition of the first material. If the second coating is not deposited on the first material within the particular amount of time, the first material can begin to degrade, leaving the substrate unusable. A time constraint window refers to an amount of time to complete a first operation (referred to as an initiating operation) and the particular amount of time a second operation (referred to as a completion operation) is to be completed. In some embodiments, one or more operations performed between the initiating operation and the completion operation are also associated with the time constraint window. In accordance with the previous example, a time constraint window can refer to a first amount of time to deposit the first material on the surface of the substrate and the particular amount of time in which the second material is to be deposited on the first material. Multiple operations can be subject to one or more time constraints. In some embodiments, a completion operation for a first-time constraint window can also be an initiating operation for a second time constraint window.

A production dispatcher system 103 and/or production scheduling system 104 can make decisions (e.g., dispatching decisions and/or scheduling decisions) to improve manufacturing productivity. For example, the production dispatcher system 103 and/or production scheduling system 104 can be used to make decisions to improve manufacturing productivity across multiple substrate processing tools of a production environment 100 (e.g., substrate processing facility). The production dispatcher system 103 may be a real-time dispatching (RTD) system that makes dispatch decisions in real-time or near real-time. A production dispatcher system 103 and/or production scheduling system 104 can enable substrate manufacturers to develop policies (e.g., dispatching policies, scheduling policies) to provide on-time production while maximizing usage of high-yield tools.

For example, production dispatcher system 103 and/or production scheduling system 104 can use a manufacturing execution system (MES) when making decisions (e.g., dispatching decisions, scheduling decisions), either by querying the MES database or by replicating the MES data into the production dispatcher system 103 and/or production scheduling system 104. The MES can be communicably coupled to a set of substrate processing tools and can gather raw facility data from various components of the production environment 100 (e.g., substrate processing facility), such as a set of processing tools, and store the raw facility data in an MES database, which can be a relational database, for example.

The production dispatcher system 103 and/or production scheduling system 104 can further include a data processing component to process the raw facility data to generate processed facility data, also referred to as state data (e.g., state data 152). The production environment 100 can further include a repository (e.g., data store 150) that can store the state data 152. The state data 152 can be used (e.g., by the production dispatcher system 103 and/or production scheduling system 104) to coordinate and optimize substrate processing tasks to meet production goals. For example, the state data 152 can be used to track individuals lots and substrates (e.g., wafers) throughout substrate fabrication, manage process recipes used by substrate processing tools to fabricate substrates, monitor the status of the substrate processing tools, perform yield management to improve overall yield of the substrate processing facility, etc.

In some embodiments, the production dispatcher system 103 can further include a set of dispatchers and/or the production scheduler system 104 can further include a set of schedulers. A dispatcher and/or scheduler may be a software application that manages the scheduling and execution of tasks performed by processing tools in a fabrication facility. For example, a task can be a substrate process performed by a substrate processing tool of the production environment 100 (e.g., substrate processing facility). In a fabrication facility, there can be multiple processing tools and multiple lots that may need to be processed at the same time. Thus, the set of dispatchers and/or scheduler can include multiple dispatchers and/or schedulers to concurrently handle multiple dispatching requests and/or scheduling requests received at approximately the same time. For example, a dispatcher and/or scheduler can one or more of optimize resource utilization, prioritize tasks, determine tasks execution order to maximize throughput, distribute workload across processing tools to optimize efficiency (e.g., load balancing), monitor a state of the substrate processing facility, etc. In particular, a dispatcher and/or scheduler can make decisions (e.g., dispatch decisions, scheduling decisions) regarding task dispatching and/or scheduling and execution to optimize task execution (e.g., improve throughput). A dispatch decision defines an action that should happen next in the manufacturing facility. For example, a dispatch decision can select a processing tool into which a substrate should be placed for processing. Examples of dispatch decisions that can be performed in a substrate processing facility can include “where a substrate lot should be processed next,” “which substrate lot should be picked for an idle substrate processing tool,” etc. The state of a substrate processing facility can include status of the substrate processing tools, status of the substrates (e.g., locations and/or processing states of substrates), status of processing tasks being performed by the substrate processing tools, etc.

To make decisions (e.g., dispatch and/or scheduling decisions), a dispatcher and/or scheduler can utilize an in-memory rule execution engine that processes a set of rules (e.g., dispatch rules, scheduling rules) based on decision data (e.g., dispatch decision data, scheduling decision data). For example, decision data can include facility data related to the substrate processing facility. Decision data can include data reflecting a state of the substrate processing facility and/or factors that can affect dispatching and/or scheduling (e.g., task scheduling and execution among the substrate processing tools). Examples of decision data can include, for example, lot information, substrate processing tool information (e.g., substrate processing tool capability and/or availability), route information, process recipe information, production goals, etc. Examples of dispatch rules can include, and are not limited to, select the highest priority substrate lot to work on next, select a substrate lot that uses the same set up which the tool is currently configured for, package items when a purchase order is complete, ship items when packaging is complete, etc. For example, the decision to be made may be “where a substrate lot should be processed next,” and the rule that may be used to make the decision may be to “select the highest priority substrate lot to work on next and select a substrate lot that uses the same set up for which the substrate processing tool is currently configured.

In some systems, dispatching rules can be configured using factors (e.g., dispatching factors, scheduling factors) such as, for example, parameters and/or a ranking order. A parameter can, for example, be any value or criterion used to determine or configure how a rule operates. For example, a parameter can include threshold values for bucket boundaries, values indicative of the relative importance of two ranking factors (e.g., a parameter that controls the relative preference of running lots on high-yield tools versus running lots as quickly as possible to meet on-time delivery requirements), batching parameters (e.g., the maximum time to wait for a full lot or batch to process), bottleneck tool indicators (e.g., which process chambers can cause a bottleneck in production, such as, for example, a process chamber preforming lithography processing), overload thresholds (e.g., the amount of work to be queued in front of a tool for the tool to be considered overloaded), and so forth. In an illustrative example of bucket boundaries, a first bucket for queue time limits can include a lower threshold limit of 10 minutes and an upper threshold limit of less than 12 minutes, a second bucket for queue time limits can include a lower threshold limit of 12 minutes and an upper threshold limit of less than 14 minutes, and so forth. The dispatching ranking order can include one or more ranking factors used to order a set of lots or substrates in a ranking order. A rule can apply the ranking order in a specified order to rank a set of lots or substrates. For example, the ranking order can first sort candidate lots based on queue time constraints, then sort based on lot priority, then sort based on feeding downstream bottlenecks, then based on critical ratio buckets, then tie break using arrival time. A time constraint can refer to a limitation or protocol in which, after an operation is performed at the fabrication facility, a subsequent operation is to be completed within a particular amount of time. For example, the fabrication facility can be subject to a time constraint where the etch process is to be performed for the substrate within a particular number of hours (e.g., 12 hours) after the coating is deposited on the surface of a substrate. If the time constraint is not satisfied (e.g., if the etch process is not performed within the particular number of hours), the substrate can become defective and unusable.

Conventionally, parameters and ranking orders are set manually by, for example, operators. This typically leads to uncertainty and varying (e.g., non-reproducible) performance of the dispatchers and schedulers.

Aspects and embodiments of the present disclosure address these and other shortcomings of the existing technology by using deep reinforcement learning for managing parameters and dispatching ranking orders at a substrate processing facility. In particular, a dispatcher and/or scheduler (or other component of a substrate processing facility) can detect a trigger condition, such as, for example, a factory event, a time period lapsing, a user request, a user-specified trigger, etc. A factory event can include any event affecting a condition or parameter of the manufacturing equipment, such as, for example, a component of the manufacturing equipment (e.g., a process chamber, a robot, a load port, etc.) becoming operational, a component shutting down, a new component installed, a component being decommissioned, a new product being introduced, a new recipe being introduced, an operational parameter being adjusted, etc. The dispatcher can then obtain data relating to the current state of the manufacturing equipment. This data can include current state data, sensor data, contextual data, task data, etc. For example, the current data can relate to one or more operations being performed on one or more substrates being processed, a number of substrates being processed at the manufacturing equipment at a particular instance of time, a number of substrates in a manufacturing equipment queue, current service life, setup data, a set of operations that include individual processes performed at one or more manufacturing facilities of a production environment, sensor data, etc. The dispatcher can provide the data relating to the current state of manufacturing equipment as input to an agent. An agent can include a software program that perceives its environment, takes action autonomously in order to achieve one or more goals, and can improve its performance with learning.

The agent 190 (also referred to herein as a software or intelligent agent) can be used to generate settings for dispatch parameters and/or a dispatch ranking order(s) (or modify existing dispatch parameters and/or ranking orders). The dispatcher can use the generated settings for the dispatch parameters and/or dispatch ranking order(s) to generate a dispatching decision. A dispatching decision can decide what action should be performed at a given time in the production environment. Examples of dispatching decisions can include, and are not limited to, where a substrate should be processed next in the production environment, which substrate should be picked for an idle piece of equipment in the production environment, and so forth. Based on the dispatching decisions data, the processing device can initiate the set of operations on the candidate set of substrates at a particular time.

In some embodiments, the agent 190 (e.g., software agent) can be trained using deep reinforcement learning. Deep reinforcement learning combines artificial neural networks with a framework of reinforcement learning that helps software agents learn how to reach their goals (e.g., deep reinforcement learning includes learning from existing knowledge and applying it to a new data set). In one example, during training, the agent 190 (e.g., software agent) selects and simulates an action (in a simulation environment) one timestep into the future. The agent 190 then receives a new environment state (e.g., state data 152, and a reward (e.g., reward data 154). The state-action-reward sequence is saved, and periodically, the reinforcement learning algorithm uses this experience to update the weights of the neural network which represents a policy. The policy is used to pick the next action. The policy updates aim to maximize the cumulative reward (e.g., reward data 154) over the time horizon. Once the learning curve stabilizes and the policy stops improving, the policy is saved and can be used on current data related to the manufacturing equipment.

Aspects and embodiments of the present disclosure address the shortcomings of the existing technology by providing techniques for generating and/or modifying the parameters 156 (e.g., dispatching parameters, dispatch ranking orders, scheduling parameters, etc.) used in selecting and scheduling a substrate or a set of substrates to be started at an initiating operation. A dispatcher and/or scheduler can use a trained agent 190 to determine the parameters (e.g., dispatching parameters and/or dispatch ranking orders). By applying the agent 190, the dispatcher and/or scheduler can obtain data used to generate a decision (e.g., dispatching decision, scheduling decision) indicative of when to schedule a set of substrates for processing. By determining when to schedule the set of substrates, the processing device can schedule the set of substates to be initiated at the set of operations to optimize performance of the substrate manufacturing equipment 112. As a result, more efficient parameters 156 are selected based on changing conditions associated with the manufacturing equipment 112. Additionally, more substrate lots will be processed on their preferred tool (e.g., higher-yield tools), resulting in a better yield. As such, the trained agent 190 (e.g., trained software agent) can improve throughput, as opposed to convention manual methods which can reduce throughput.

In some embodiments, the functions of client device 114 and/or server device 110 are to be provided by a fewer number of machines. For example, in some embodiments, client device 114 and/or server device 110 are integrated into a single machine.

In general, functions described in one embodiment as being performed by client device 114 can also be performed on server device 110 in other embodiments, if appropriate. In general, functions described in one embodiment as being performed by server device 110 can also be performed on client device 114 in other embodiments, if appropriate.

In addition, the functions of a particular component can be performed by different or multiple components operating together. In some embodiments, one or more of the server device 110 or client device 114 are accessed as a service provided to other systems or devices through appropriate application programming interfaces (API).

Although embodiments of the disclosure are discussed in terms of reinforcement learning for yield improvement using dispatching in substrate processing systems, in some embodiments, the disclosure can also be generally applied to reinforcement learning for yield improvement. Embodiments can be generally applied to yield improvement.

FIG. 2 illustrates an example system 200 for performing reinforcement learning to generate an agent 202 (e.g., software agent, agent 190 of FIG. 1), according to certain embodiments of the present disclosure. Example system 200 includes agent 202 (e.g., software agent) and environment 204 (e.g., simulation environment, a simulator). Agent 202 takes actions that affect environment 204 and change state (e.g., the environment state) of the environment 204. The environment state is a representation of the current environment that the agent 202 is in. This state can be observed by agent 202, and the state includes all relevant information about the environment 204 that agent 202 needs to know in order to make a decision (e.g., perform an action 210). Following each action 210, agent 202 transitions to the next environment state 212 and receives a reward (e.g., next reward 214).

Agent 202 can use one or more machine learning models 240. The machine learning model 240 can be, for example a deep neural network (e.g., a convolutional neural network, transformer, graph neural network etc.) or decision trees. The machine learning model 240 can use reinforcement learning. Machine learning model 240 can represent a policy (e.g., a solution policy). The policy can be a strategy of actions that promises the highest long-term reward.

Agent 202 can be rewarded for taking controls that lead to successful environment states. The rewards can be immediate, such as receiving a point for each operation taken in the right direction, or the rewards can be delayed, such as receiving a point at the end of the episode if the goal was reached. An episode can refer to a sequence of environment states 206, actions 210, and rewards 208, which ends with terminal environment state. In an illustrative example, each episode (or experiment) can include 100 timesteps, and each timestep can take 100 minutes. At each timestep, agent 202 can take a single action. Following the action, agent 202 receives an observation (e.g., environment state data) reflecting the state of environment 204 at the end of the timestep. An episode terminates when 100 timesteps have passed, or, for example when a predetermine number of lots (e.g., 10 lots) complete the route, whichever happens first.

In some embodiments, example system 200 uses the Markov Decision Process (MDP) formalism where agent 202 attempts to optimize a function in its environment 204. An MDP can be described by an environment state space S (with states s∈S), an action space A (a∈A), a transition function T:S×A→S and a reward function R:S×A→ [symbol] . In an MDP, an episode evolves over discrete time steps t=0, 1, 2, . . . , n, where the agent 202 observes an environment state St (206) and responds with an action aₜ (210) using a policy π(aₜ|sₜ). The environment 204 provides to the agent 202 the next environment state sₜ₊₁˜T (sₜ, aₜ) 212 and the reward rₜ=R(sₜ, aₜ) 214. The agent 202 is tasked with maximizing the return (cumulative future rewards) by learning an optimal policy π*.

In some embodiments, dispatching and/or scheduling management can be modeled as a discrete-time, finite-horizon MDP which is a tuple M=(S, A, P, R, ρ⁰, T), where S is a environment state set, A an action set, P:S×A×S→R+ a transition probability distribution, R:S×A→R a reward function, ρ⁰:S→[0, 1] an initial environment state distribution, and T the time horizon. A solution policy can be a probability distribution π:S×A→[0, 1] that maps environment states to actions. To find a solution policy, agent 202 can be trained to learn a policy which maximizes the expected return

$${E}_{τ} {\sum }_{t = 0}^{T} R ( {s}^{t} , {a}^{t} )$$

where τ:=(s⁰, a⁰, s¹, a¹ . . . ) denotes a trajectory, s⁰˜ρ⁰, a^{t}˜π(s^{t}), s^{t+1}˜P(s^{t},a^{t}).

In some embodiments, during training, agent 202 takes an action 210. Environment 204 applies that action and simulates one timestep into the future. Agent 202 then receives new environment state data 212 and a new reward 214. The state-action-reward sequence is stored, and periodically, the reinforcement learning algorithm uses this experience to update the weights of the neural network (e.g., machine learning model 240) which represents the policy. The policy is used to pick the next action 210. The policy updates aim to maximize the cumulative reward over the time horizon. Once the learning curve stabilizes and the policy stops improving, processing logic (e.g., training engine 182) can store the policy and use it to test the performance of software agent 202 on one or more of environments. In some embodiments, training includes running many simulations in parallel (e.g., running one or more instances of the following in parallel: take an action, apply the action, simulate one timestep into the future, receive new environment state data 212 and a new reward 214, store the state-action-reward sequence, and use this experience to update the weights of the neural network that is used to pick the next action). Training can include running multiple simulations in parallel to update the weights of the neural network (e.g., machine learning model 240) which represents the policy.

Environment state data (e.g., data relating to the state of environment 204) can include manufacturing equipment properties (e.g., step processing times, queue time constraints, etc.), manufacturing equipment observations (e.g., the number of substrates or lots processing per step, the number of lots processing per stations, etc.), queue time observations (e.g., the number of successful lots processed, the number of lots in violation, the number of lots in process, etc.), capacity observations (e.g., an estimation of the time to complete all the work in progress (WIP)), quantities of lots or substrates waiting to process various steps and/or waiting to start various time constraints, etc. The state features can be normalized to values in [0,1] and concatenated into a single observation vector.

At each time operation, agent 202 can decide at a value(s) for one or more parameters (e.g., parameters 156 of FIG. 1, dispatching rules, ranking order). For example, agent 202 can choose a discrete action between 0 to N, where choosing an action 0 does not change any values and/or ranking orders and action aᵢ changes a value of a particular a particular dispatching rule and/or ranking order. The reward structure can be configured such that it encourages agent 202 to select or modify a dispatching rule (e.g., select or modify at least one of a dispatching parameter(s) and/or a dispatching ranking) while maximizing on-time-delivery and processing lots on preferred stations. The reward structure can also be configured such that it encourages agent 202 to maximize the throughput of the manufacturing equipment.

In some embodiments, a trained reinforcement learning agent 202 is used to feed information to a dispatching and/or scheduling system that the dispatching and/or scheduling system uses to increase the number of lots that process on higher-yield tools.

The present disclosure may provide an automatic method configured to manage tradeoff (e.g., between on-time delivery and processing lots on higher-yield tools). The present disclosure may not have a user manually managing dispatching rule weights or manually changing dispatching rule ranking factors. The present disclosure allows the parameters (e.g., dispatching system and/or scheduling system) to be updated frequently instead of infrequent (e.g., weekly, updates associated with manual updates). Manual updates may depend on tribal or expert knowledge that is not easily communicated or reproduced.

The present disclosure may use parameters (e.g., parameters 156 of FIG. 1, dispatching parameters, scheduling parameters, ranking order, dispatching ranking order, scheduling ranking order, etc.) to maximize use of higher-yield tools while meeting other metrics (e.g., on-time delivery).

In some embodiments, a dispatching rule can have one or more parameters (e.g., parameters 156, dispatching parameters) that affect how the dispatching rule behaves. In some examples, thresholds can be used for converting a continuous value into buckets. The parameters (e.g., parameters 156, dispatching parameters) are the thresholds that define the buckets. One bucket is [0,p₁) the next is [p₁,p₂) with parameters p₁,p₂. Critical ratio or bottleneck loading can be bucketed this way.

A parameter (e.g., parameters 156 of FIG. 1) may control the relative importance of processing on stations with higher yield versus processing quickly to meet on-time delivery.

In some embodiments, a dispatching rule may have several ranking factors used to order the lots in the dispatching list. The dispatching rule may apply the ranking factors in a specified order to rank the lots. For example, the dispatching rule may first sort based on queue time constraints, then sort based on lot priority, then sort based on feeding downstream bottlenecks, then based on critical ratio buckets, and then tie break using arrival time.

Conventionally, different tools (e.g., at leading-edge nodes) may have different yields when processing the same processing operation. Sometimes a tool has higher yield for all or many processing operations. Sometimes a tool has higher yield for a few processing operations. The fab (e.g., fabrication facility, substrate processing facility) area manager wants to maximize the number of lots that process on higher-yield tools for the lots' processing operations. However, conventionally the most important factor for the area manager is on-time delivery, but on-time delivery and processing on higher-yield tools conflict. On-time delivery is achieved by processing lots as quickly as possible. Processing on high-yield tools is achieved by waiting to process lots to see if a higher-yield tool becomes available.

Conventionally, it is difficult to manage this tradeoff. Conventionally there are the questions of how long to wait to process a lot without risking on-time delivery, will it be worth waiting, and/or will a high-yield tool for the processing operation of the lot to become available soon enough.

The present disclosure provides reinforcement learning (RL) and dispatching and/or scheduling. The present disclosure may use RL to train an agent 202 (e.g., machine learning model) that tunes the dispatching rule or scheduler to improve the number of lots that process on tools that give higher yield while maintaining or improving other factors (e.g., on-time delivery goals).

Offline, processing logic may train an RL agent 202 (e.g., machine learning model) to maximize the number of lots that process on high-yield tools while maintaining or improving other factors.

Processing logic may train the agent 202 (e.g., machine learning model) on a given schedule (e.g., once a week, in response to a factory event, or other user-specified methods). The training may be based on factory events (e.g., tools going up, going down, new tool installs, tools being decommissioned, new product introductions).

To train a new agent 202 (e.g., machine learning model), processing logic may extract fab current state and optionally historical state (e.g., fab state from one day ago, two days ago, etc.). The processing logic may optionally perturb the previous state to create new state (e.g., perturb current work in progress (WIP)), and use the state(s) as initial conditions for scenarios to train the agent (e.g., machine learning model).

When a new agent 202 (e.g., machine learning model) is trained, the agent 202 is passed to the fab (e.g., substrate fabrication facility, substrate processing facility) to be used in running the fab.

In the fab, the system periodically or in response to an event extracts system state and feeds it to the agent 202. The agent 202 outputs information used to tune the dispatching and/or scheduling system.

In some embodiments, an example of dispatching and/or scheduling tuning includes having the RL agent 202 feed one or more numbers (e.g., parameters 156 of FIG. 1) to the dispatcher and/or scheduler. For example, the RL agent 202 indicates to the dispatcher and/or scheduler a maximum amount of time lots that can wait before processing on a low-yield tool.

In some embodiments, an example of dispatching and/or scheduling tuning includes having the RL agent 202 feed per-part or per-operation information to the dispatcher and/or scheduler. For example, the RL agent 202 indicates to the dispatcher and/or scheduler that certain parts or operations can wait a certain amount of time before processing on a low-yield tool.

In some embodiments, an example of dispatching and/or scheduling tuning includes having the RL agent 202 feed information about a set of lots to the dispatcher and/or scheduler. For example, the RL agent 202 indicates to the dispatcher/scheduler to pass a maximum waiting time for each WIP lot.

FIG. 2B illustrates a system 200B, according to certain embodiments. The system 200B may have an offline portion 220 and an online portion 222. The offline portion 220 may receive training data 232 (e.g., current state data 234, historical state data 236, perturbed state data 238) from state data 230 of the online portion 222. At least a portion of the training data 232 may be received from fab data (e.g., state data 230). The training data 232 may be provided to perform RL training 242 to generate a trained agent 202. The trained agent 202 may be used via agent execution 246 where state data 230 (e.g., fab data) is provided to the trained agent 202 and tuning information 248 (e.g., parameters 156 of FIG. 1) is output from the trained agent 202. The dispatching and/or scheduling system 250 may use fab data and tuning information to output dispatching and/or scheduling decisions 252.

In some embodiments, the training data 232 includes perturbed state data 238 that includes state perturbations. The state perturbations may include perturb WIP (e.g., duplicate lots, remove lots, move lots forward or backward in a route, etc.), perturb future preventative maintenances or tool downs, and/or others. In some embodiments, full fab historical data may be limited to a single tool group (e.g., implant) and use it to train the RL agent 202. Historical arrivals at the tool group may be used as new lots in the RL episodes. The current state from one point in the past may be used and combined with arrivals at another point in the past to create a perturbed episode.

In some embodiments, the present disclosure is directed to improving yield in semiconductor (e.g., substrate) manufacturing (e.g., processing) using reinforcement learning (RL) to tune a dispatching rule parameter (e.g., parameter 156 of FIG. 1) to increase the number of lots that process on higher-yield equipment. A dispatching rule may have a parameter (e.g., parameter 156 of FIG. 1, dispatching parameter) that controls whether or not the dispatching rule allows a lot to process on a lower-yield equipment or waits to allow the lot to possibly process later on a high-yield equipment. In a factory such a parameter would be set periodically (e.g., once a week), but reinforcement learning may allow the parameter to be updated frequently, leading to better factory performance. The present disclosure may provide measure of on-time delivery where the goal is to have 95% on-time delivery a set of time intervals (e.g., shifts). A trained RL agent 202 (e.g., using a graph neural network) may outperform the baseline by maintaining on-time delivery while processing significantly more lots on high-yield equipment than conventional systems.

Dispatching and scheduling in the semiconductor industry conventionally provide problems. The present disclosure may include dispatching in the implant area of a semiconductor factory. Implant is characterized by long setup times that make it difficult to estimate the future processing capacity given a set of lots to process. Two factors may be considered for an implant area: on-time delivery; and improving yield.

On-time delivery may be an important factor (e.g., for the manager of an equipment area). The area is to process the lots quickly enough that the lots will be able to be shipped on time and that downstream areas will be fed properly.

Yield has long been important at the equipment level, but only recently has it become important at the dispatching level. Empirically a factory has data that, for certain process operations, certain equipment will have higher yield than other equipment. These differences between equipment may be small (e.g., a few percentage points or less), so historically the differences were not widely considered when making dispatching decisions. However, at leading-edge nodes with their longer and more complex process flows, the value of a single wafer increases, yield becomes more important. For this reason, it has become more important when making dispatching decisions to try to process lots on equipment that have high yields.

These two metrics (e.g., key performance indicators (KPIs)) are in conflict. To improve on-time delivery, lots may be processed as quickly as possible. To improve yield, waiting to process a lot until a high-yield equipment becomes available may be used. The present disclosure may provide for managing the tradeoff between these two factors (e.g., using deep reinforcement learning and/or graph neural networks).

The present disclosure may use graph neural networks (GNNs) to allow the neural network to handle varying inputs, including varying numbers of lots, varying operations, and varying equipment configurations. Conventional approaches using multi-layer perceptrons (MLP) have fixed-length vectors as input which require workarounds like padding variable-length inputs a fixed length vector, which then forces the MLP to learn the difference between the real input and the padding. The GNN also has the advantage that its input, the graph, may explicitly model the relationships between the lots, equipment, and setups in the factory which may make it easier for the agent 202 to learn compared to conventional solutions.

Reinforcement learning is one of the branches of machine learning along with supervised learning and unsupervised learning. In reinforcement learning an agent 202 (e.g., machine learning model) is given observations about an environment (e.g., state data 230). The agent 202 then performs an action (e.g., action 210 of FIG. 2A) which changes the environment (e.g., environment 204 of FIG. 2A), after which the agent 202 is given a reward (e.g., reward 208) and new observation (e.g., state 206, next state 212). This cycle repeats. The agent 202 is trained to choose actions 210 which maximize the reward 208 it receives.

In deep reinforcement learning, the agent 202 (e.g., machine learning model) is represented by a neural network which maps the observation (e.g., state data 230, state 206 of FIG. 2A) onto the action (e.g., action 210 of FIG. 2A) to be performed. Deep reinforcement learning may be used successfully in domains such as computer games, complex games, robotics, and control.

In some embodiments, simple dispatching rules like shortest processing time, earliest due date, or critical ratio may be used. In some embodiments, the rules that are used in semiconductor factories are more complex since the rules need to manage multiple competing factors. As factory conditions change (e.g., as factory loading increases or decreases), the different factors managed by the rule can change, so the rules may have parameters that manage the relative importance of the various factors. These parameters may be periodically set based on current conditions (e.g., manually based on experience, using a simulation coupled with optimization).

In some embodiments, reinforcement learning may be used to control dispatching parameters. In this case, the RL agent 202 may take as input the current factory (e.g., fab) conditions (e.g., state data 152 of FIG. 1, state 206 of FIG. 2A, state data 230 of FIG. 2B) and produce as output the parameters (e.g., parameters 156 of FIG. 1, dispatching parameters) to be used for those conditions. Such a system may allow the parameters to be set without having a human expert available and may allow the parameters to be changed more frequently, allowing the rule to adapt more quickly to factory changes.

In some embodiments, graph-neural networks (GNN) may be used for dispatching and scheduling. The structure of the graph that is input into the GNN and/or how the GNN is used in the overall reinforcement learning network may vary.

In some embodiments, using RL for scheduling and/or dispatching optimizes makespan or average cycle time. On-time delivery (e.g., a binary value for each lot indicating if the lot processed on time, which is similar to tardiness, may be a real number for each lot that is positive if the lot is late and zero if it is on time), optimize total weighted tardiness (e.g., which close to optimizing global average on-time delivery), minimize total tardiness, and/or minimize average tardiness may be considered. Conventionally, optimizing on-time delivery percentage or the more complex on-time delivery metric (e.g., key performance indicator) of the present disclosure is not directly considered.

The present disclosure may use RL to tune a parameter (e.g., parameter 156 of FIG. 1) of a dispatching rule. RL for dispatching and scheduling may be used to replace the dispatching rule by having the RL agent 202 directly select the lot that should process next. The RL agent 202 may be used to select among a prespecified set of dispatching rules.

In some embodiments, simulation models may be used (e.g., to train and evaluate the RL agent 202). The simulation models may be similar to a single implant equipment group in a medium-sized factory. The simulation models may include (e.g., only include) a single equipment group (e.g., all routes have a single operation).

Each implant operation may be modeled as having two different types of setups: an energy setup; and a recipe group setup. Changing an energy setup of equipment may be expensive and take a long time (e.g., hours), while changing the recipe group setup may be much shorter.

Each simulation model may be randomly generated using one or more of the following parameters:
About ten implant equipment;
Operation processing time between about 10 minutes and about 20 minutes;
Each operation has a cycle time target equal to 13 times the processing time (e.g., this may be used to calculate a due date for each lot);
About 90% of the operations have two randomly-chosen stations with high yield (e.g., the remaining operations have one randomly-chosen station with high yield);
30% of operations require high energy and the remaining operations require low energy;
Setup change from high energy to medium energy takes about 2 hours;
Setup change from medium energy to high energy takes about 3 hours;
Between about 12 and about 16 recipe group setups;
Recipe group setup change time takes between about 25 minutes and about 35 minutes;
Varying average lot arrival rate as described in the experiments below;
Individual lot arrivals are randomly perturbed so that there is variation in lot arrivals while maintaining the average lot arrival rate;
The lot arrival rates are low enough that the on-time delivery goals can be met;
Initial WIP tuned to match the lot arrival rate; and/or
Randomly created preventative maintenance operations (PMs) with random duration of about four, six, or eight hours such that the equipment group is in the PM state a specified percentage of the time as described in the experiments of the present disclosure.

Using the above parameters, multiple training models (e.g., about five hundred training models) and multiple evaluation models (e.g., about one hundred evaluation models) without PMs and multiple evaluation models (e.g., about 150 evaluation models) with PMs. The evaluation models may have substantially evenly spaced lot arrival rates and PM rates, which the training models have values chosen substantially uniformly from an input range. When using the models for training, the models may be run for a warmup period of about three hours with a fixed value for the dispatching parameter.

The training models may include different operation processing times and different numbers of recipe groups, which means that the trained agent will be robust to factory changes like new products, recipe changes, etc.

The behavior of the simulation may be controlled using a dispatching rule that selects the next lot an equipment should process or returns that the station should remain idle. This dispatching rule includes a parameter that is used to control how the dispatching rule manages the tradeoff between on-time delivery and processing on higher-yield equipment (e.g., this may be the parameter that is controlled by the RL agent 202). The dispatching rule may be implemented using software (e.g., APF Formatter™ and/or Fusion™ software) that allows easily building and integrating a complex rule with the simulation.

The dispatching rule may include one or more of the following functionalities:
No two equipment may have the same energy and recipe group setups;
An energy setup change is done (e.g., only done) if there are a sufficient number of lots waiting for the new energy setup;
An energy setup change is not done if there are many lots waiting for the current energy setup;
The number of stations with high energy setup is to remain within one of the target of about 30% of the total number of stations;
The dispatching rule has a parameter T such that, if a lot can be selected to an equipment and that equipment is not high-yield for that lot's operation, then the lot will not be selected if the remaining time until the lot's due date is greater than T (e.g., this parameter may be tuned by the RL agent 202, this can cause equipment to be left idle, this definition of the parameter may imply that large values of T mean that the equipment group will process lots as quickly as possible, while small values of T mean that equipment group will wait as long as possible to process lots);
Order the lots based on critical ratio; and/or
As a tiebreaker, the dispatching rule prefers processing lots with earlier due dates and lots whose ID is lexicographically earlier (e.g., this makes the dispatching rule deterministic).

The present disclosure may have one or more performance factors (e.g., key performance indicators (KPIs)). In some embodiments, two factors are used to evaluate the performance of the baselines and RL agent: on-time delivery over a specified time interval; and the percentage of lots that process on high-yield equipment.

On-time delivery may be calculated similar to how an area manager would be measured in a fab. Over a specified time interval, the percentage of lots that finish on time may be computed. This percentage is to be greater than or equal to a threshold value (e.g., about 95%) for the on-time delivery goal to be met for that interval. The percentage of time intervals where the threshold value (e.g., about 95%) on-time delivery is met may be reported.

In the fab, the time interval may be one shift or one day. In the present disclosure, to make the neural network training somewhat easier to train, the interval given by about 32 time operations (e.g., about 16 hours) may be used. In some examples, 32 is chosen because it is a power of two.

The second factor (e.g., KPI) is yield as measured by the percentage of lots that start processing on one of their operation's high-yield equipment divided by the total number of lots that start processing.

There may be a tradeoff between these two factors (e.g., KPIs): achieving on-time delivery may mean that the equipment group should process lots as quickly as possible; but increasing yield may mean that the equipment group should wait to process lots to see if the equipment group can process on a high-yield tool. Competing objectives like this may cause performance of a delicate weight balancing process to obtain solutions. The mathematical structure of the on-time delivery factor (e.g., KPI) may cause this to be unnecessary. For any given time interval, the on-time delivery may be a binary value: either the equipment group achieves the goal or the equipment group fails. The factories that are modeled may be well-run (e.g., on-time delivery is achievable, the weights given to the two factors (e.g., KPIs) may not matter as long as on-time delivery weight meets a threshold value). Conceptually, the RL agent is to discover the region where on-time delivery is achieved, then, within that region, figure out how to maximize yield.

In some embodiments, RL training and policy updates are used. For RL agent training, the Proximal Policy Optimization algorithm (e.g., an actor-critic deep RL algorithm that uses on-policy learning to train a stochastic policy using gradient descent) may be used.

In some embodiments, the environment may be implemented as a Gymnasium environment (e.g., using a python wrapper for the AutoSched™ software). This wrapper allows individual values to be passed from the wrapper to a Fusion™ dispatching rule in the model which is used to implement the actions. This also allows the wrapper to run Fusion™ reports which are used to get the simulation information used to construct the observation (e.g., state observation).

The present disclosure may have a state observation (e.g., state data 152 of FIG. 1, state 206 of FIG. 2A, state data 230 of FIG. 2B, etc.). The state observation may include two components. The first component of the state observation may be a vector including one or more of:
The number of WIP lots;
The number of lots that will arrive in the next threshold amount of time (e.g., in about the next two hours);
Information about the on-time delivery state of the area (e.g., the number of lots ahead or behind the on-time delivery goal of 95%); and/or
The number of time operations until the on-time deliver reward will be reported.

The second component of the state observation may be a graph describing the state of the lots and equipment in the area. The graph is heterogeneous (e.g., the graph contains different types of nodes and edges). The graph has a node for each lot, either in current WIP or that will arrive in the next threshold amount of time (e.g., about the next two hours), a node for each equipment, and a node for each recipe group setup that is not currently on an equipment. The lot nodes have attributes giving the processing time for the lot and number of hours until the lot is due. The station nodes have attributes giving the number of hours until the station will be available to process another lot and the number of hours until the next PM.

FIG. 2C illustrates an observation graph 201, according to aspects of the present disclosure. The observation graph 201 may be associated with a state observation (e.g., state data 152 of FIG. 1, state 206 of FIG. 2A, state data 230 of FIG. 2B, etc.).

The observation graph 201 may include lots 254 (e.g., L1-L9), equipment 256 (e.g., E1-E5), and/or setup nodes 258 (e.g., S1-S2). Lots 254 are different lots (e.g., groupings, enclosures) of substrates. Equipment 256 may be manufacturing equipment 112 of FIG. 1 (e.g., higher-yield tools and lower-yield tools). Setup node 258 may be operations to be performed on the lots 254 prior to being processed by equipment 256.

The observation graph 201 may include edges 260 that include same setup edge 260A, higher yield edge 260B, lot setup edge 260C, and/or same energy setup edge 260D. The edges 260 may connect lots 254 with equipment 256, lots 254 with setup node 258, and/or setup node 258 with equipment 256.

The observation graph 201 may include the one or more of the following types of bidirectional edges 260:
Same setup edge 260A—an edge 260 between each lot 254 and equipment 256 where the equipment 256 has the correct setup for the lot 254 and where the equipment 256 is high-yield for the lot's 254 operation (e.g., same setup edges 260A have a binary attribute indicating if the equipment 256 is high-yield for the lot's 254 operation);
Higher yield edge 260B—an edge 260 between each lot 254 and each equipment 256 where the equipment 256 is high-yield for the lot's 254 operation and where there are no other edges between the lot 254 and equipment 256;
Lot setup edge 260C—an edge 260 between each lot 254 and setup node 258 where the lot's 254 operation requires the setup represented by the setup node 258 (e.g., lot setup edges 260C may be created if no equipment 256 has the setup to be used by the lot's 254 operation); and/or
Same energy setup 260D—an edge 260 between each setup node 258 and each equipment 256 where the setup has the same energy setup as the current energy setup of the equipment 256.

In FIG. 2C, Lots L1, L8, and L9 may not have an equipment 256 with their operation's required setup, so they have lot setup edges 260C to setup nodes 258 representing their required operations. The rest of the lots 254 have equipment 256 with the required setup, so they have edges 260 to the equipment node (e.g., equipment 256) with the correct setup. Lots L1, L2, L3, L6, L8, and L9 have high-yield equipment that does not have the correct setup so they have an edge to those equipment. S1 has same energy setup edges 260D to the two equipment 256 with the same energy setup as S1, meaning that a short recipe group setup change time is required to switch to S1 and thus be able to process L1.

The present disclosure may have an action space. The action space may be a one-dimensional continuous space giving one or more dispatching parameters described herein.

The action space may be normalized so that the output of the neural network is in the interval [−1,1].

The present disclosure may have a reward function (e.g., reward data 154 of FIG. 1). The reward function may be given by:

$${R}_{i} = {W}_{yield} \frac{{P}_{i}}{{N}_{i}} + {W}_{otd} \{ \begin{matrix}0 & if i + 1 mod 32 \neq 0 , \\ 0 & if i + 1 mod 32 = 0 and OTD goal met , \\ - 1 & if i + 1 mod 32 = 0 and OTD goal not met ,\end{matrix}$$

Rᵢ is the reward (e.g., reward data 154 of FIG. 1) for time operation i. W_{yield} is the weight for the yield portion of the reward. Pᵢ is the number of lots that start processing on high-yield equipment during the operation. Ni is the total number of lots that start processing during the operation. W_{otd} is the weight for the on-time delivery portion of the reward. The constant 32 is the number of operations in the time intervals over which on-time delivery is calculated (e.g., as discussed in the present disclosure). The on-time delivery reward may be zero except at the end of a time interval where the on-time delivery goal was not met, in which case it is −1.

There may be a delay in the actions that affect the on-time delivery and when the reward is reported to the agent. Such delayed rewards can cause agent training to be more difficult.

The weights W_{yield} and W_{otd} may not affect the final training result (e.g., they may affect training speed). In some embodiments, 2000 W_{yield}=W_{otd}. The reward returned to PPO may be scaled to the interval [−1,1] so the exact values are arbitrary.

The present disclosure may include a neural network. The present disclosure may include: a graph representing the state of the lots and equipment; and an additional vector giving global information about the simulation and factors (e.g., KPIs). The policy and value networks used by PPO may be given by MLP neural networks that take a vector of fixed dimension as input. A way to convert the state graph into a vector may be used. Alternatively, a way to calculate a set of features which represent the graph may be used.

The present disclosure may use graph embedding. To convert the graph information into a vector that can be fed to PPOs multi-layer perceptron (MLP network, graph embedding may be used. Graph embedding may create a function that takes a graph as input and outputs an n-dimensional vector (e.g., graph embedding may embed the graph in n-dimensional space for some n). This can also be viewed as creating n features that represent the graph. Graph neural networks may be used based on message passing layers to perform graph embedding. The output of the message passing layers may be a vector for each node in the graph (e.g., node embedding). To convert the node embedding to a graph embedding, the nodes of each type may be aggregated and then the resulting three vectors may be concatenated to give a single graph embedding vector. If G=(n^{L}, n^{E}, n^{S}, E) is the graph with lot nodes, equipment nodes, setup nodes, and edges, respectively, then applying the GNN to a graph gives:

$$GNN ( G ) = GNN ( {n}_{i}^{L} , {n}_{j}^{E} , {n}_{k}^{S} , E ) = ( {e}_{i}^{L} , {e}_{j}^{E} , {e}_{k}^{S} )$$

The right-hand side are n-dimensional embeddings of the lot, equipment, and setup nodes, respectively. The graph embedding e^{G} can be written as:

$${e}^{G} = 〈 {\sum }_{i} {e}_{i}^{L} \vert {\sum }_{j} {e}_{j}^{E} \vert {\sum }_{k} {e}_{k}^{S} 〉 ,$$

The [symbol] ⋅|⋅ [symbol] denotes vector concatenation.

The vector e^{G} is then concatenated with the vector portion of the observation to get the vector which is the input to the usual MLPs in the PPO agent. This architecture allows us to train the graph embedding and the PPO networks simultaneously (e.g., see FIG. 2D).

FIG. 2D illustrates a system 200D, according to certain embodiments. FIG. 2D may illustrate a policy or value neural network. The system 200D of FIG. 2D includes one or more of: MLP layer equipment features 272; MLP layer lot features 274; one or more GNN layers 276; lot node aggregation 278; equipment node aggregation 280; setup node aggregation 282; concatenate 284; policy/value MLP 286; and/or observation 288 (e.g., state data).

The system 200D may be a graph neural network (GNN) that is a message passing network and may include two-layer MLP networks to pre-process the lot (e.g., MLP layer lot features 274) and station features (e.g., MLP layer equipment features 272). These pre-processing MLPs (e.g., 272, 274) may improve performance significantly. The network may be implemented using torch-geometric (e.g., library for writing and training GNNs).

PPO may be an actor-critic method and may have a neural network for the policy and a network that predicts the value of a given state. The problem may have separate GNNs (e.g., GNN layers 276) for the policy and action networks (e.g., have separate feature extraction for the policy and action networks).

During training, the simulation may start with warmup period (e.g., about three-hour warmup period) followed by multiple time operations (e.g., about 256 time operations of about 30 minutes). The RL agent 202 updates the parameter (e.g., dispatching parameter) at each time operation. RL agent 202 may be evaluated by running the baseline models with the RL agent 202 updating the dispatching parameter about every 30 minutes of simulated time. The models may be run for about 256 operations of about thirty minutes after about a thirty-minute warmup.

The agent 202 trained on models without PMs may be trained for approximately 800,000 time operations and the agent trained on models with PMs may be trained for approximately 1,770,000 timesteps.

A stepped learning rate decay may be used with an initial learning rate of about 1e-3 and a final rate of about 1e-5 with about three operations between. Other PPO parameters may be used.

The RL agents 202 may be compared to a baseline (e.g., baseline agent) that is similar to a factory (e.g., substrate processing facility) where the parameter (e.g., dispatching parameter) is manually set periodically (e.g., once a week, based on factory conditions). For example, the factory employees that manage an implant equipment group might meet once a week and consider the current product mix, factory loading, upcoming PMs, and other factory data and determine dispatching parameters for the next week.

To create a baseline similar to this factory behavior, baseline simulation models may be generated for sets of (λ, π), where λ is the lot arrival rate and π is the percentage of time the equipment group is in the PM state. The models may be generated as described in the present disclosure. Each group of simulation models for fixed (λ, π) corresponds to a fixed factory state. For each of these groups, the value of the parameter T (e.g., dispatching parameter, scheduling parameter) may be found that results in about 100% of the time intervals meeting the on-time delivery goal and that maximizes the average percentage of lots that process on their operation's higher-yield tools (e.g., high-yield equipment) (e.g., across all simulation model sin the group). This may be an optimization of a one-dimensional, monotonic function with some noise. The optimal value for parameter T may correspond to the factory employees picking the dispatching parameter based on the fab conditions (e.g., corresponding the models in the group). The optimization may be repeated for each group of models with the same (λ, π). The result of this process is a map from (λ, π) to an optimal fixed value of the dispatching parameter. This fixed mapping may be used as the baseline agent.

In some embodiments, the RL agent 202 is evaluated by running the evaluation models with the RL agent 202 updating a parameter (e.g., parameter 156 of FIG. 1, dispatching parameter) about every 30 minutes of simulated time. The models may be run for about 256 operations of about 30 minutes after about a three-hour warmup.

The present disclosure may have results without PMs. The equipment group may be close to fully loaded when the lot arrival rate is about 23 lots/hour. Based on this, about 500 training models that have lot arrival rate λ selected from a uniform distribution on the interval [21, 23] and PM percentage π equal to zero. For evaluation models, λ∈{21, 22, 23} with 50 models for each value are used, giving a total of 150 evaluation models. The baseline may be calculated as described herein and the agent 202 may be trained as described herein. The evaluation results are in Table 1. The RL agent 202 may outperform the baseline on both on-time delivery and percentage of lots that process on high-yield equipment.

TABLE 1
Comparison of RL agent 202 with the
baseline using models without PMs:

| | Baseline | Agent |
|---|---|---|
| Percentage of Intervals | 97.9 | 99.0 |
| Meeting OTD | | |
| Percentage of Lots | 37.4 | 41.6 |
| Processing on High-Yield | | |
| Equipment | | |
| Average Action | 3.65 | 3.28 |

Table 1 also includes information about the average action (e.g., average parameter value T, average dispatching parameter) taken by the agent and baseline across all models and time operations. The values are quite different, indicating that the agent has not simply converged to a policy similar to the baseline.

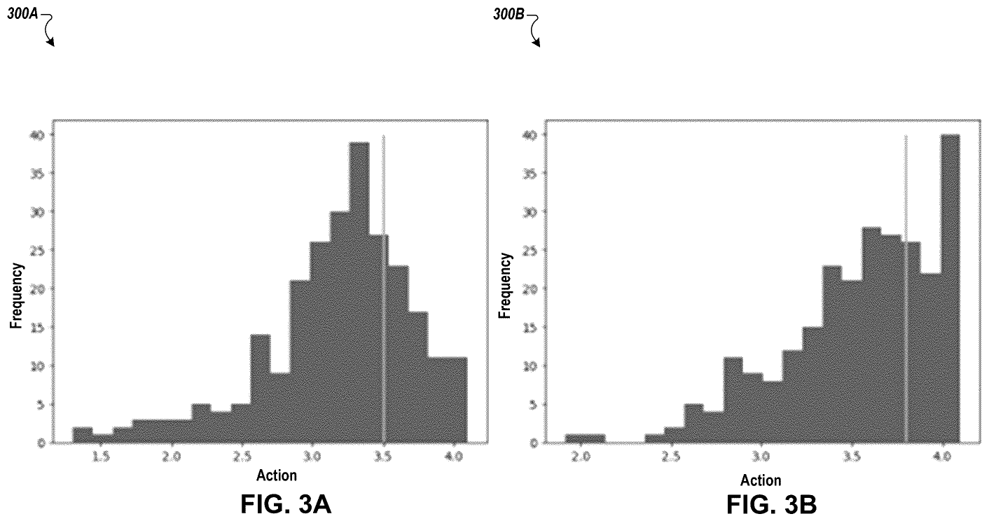

FIGS. 3A-B illustrate graphs 300A-B, according to certain embodiments. FIGS. 3A-B have distributions of the actions (e.g., action distributions) of the agent (e.g., agent 202 of FIGS. 2A and/or 2B) for two models. FIGS. 3A-B illustrate action distributions for the agent for two models (e.g., two randomly-selected simulation models, two example simulation models). The vertical line may be the constant action for the baseline agent for the model.

The present disclosure may have results with PMs. The RL agent outperforms the baseline because the RL agent can react quickly to changing factory conditions whereas the baseline remains static.

In some embodiments, PMs may disrupt the normal operation of the equipment group. If the RL agent is outperforming because the agent reacts more quickly, the outperformance may increase as the number of disruptions increases (e.g., as the number of PMs increase).

Before generating the training models, for PM percentage π equal to 8, 10, and 12, it may be determined experimentally that the equipment group is fully loaded if the lot arrival rate λ is equal to 13.6, 11.3, 8.2, respectively. Based on this, about 500 training models may be generated with the PM percentage π drawn from a uniform distribution on [8,12] and λ chosen by interpolating the experimentally determined values above. The evaluation models have values π∈{8,10,12} and corresponding λ∈{13.6,11.3,8.2}. About 50 training models may be generated for each (π,λ), giving 150 evaluation models. The baseline may be calculated as described herein and the agent may be trained as described herein.

In some embodiments, there may be a fixed range of percentages of time where the equipment group is down due to a PM. The maximal lot arrival rate that allows the on-time delivery goal to be met may be determined (e.g., experimentally). Using these parameters, a training set (e.g., of about 500 models) may be created with substantially continuously varying PM percentages and lot arrival rates and also an evaluation set (e.g., of about 150 models) with a discrete set of values. The baseline may be calculated (e.g., as above) and the agent is trained (e.g., as above).

Table 2 gives the results of the baseline and agent on the evaluation set of models. As the percentage of time spent in the PM state increases from 0.08 to 0.10 to 0.12, the agent outperforms the baseline by 18%, 47%, and 52%.

TABLE 2
Comparison of RL agent against the baseline using models with PMs

| | | | | Pct of Lots | | |
|---|---|---|---|---|---|---|
| | Lot Arrival | Pct of Intervals | | Processing | | |
| | Rate | meeting OTD | | on High-Yield Eqp | | Percent |
| PM % | (lots/hour) | Baseline | Agent | Baseline | Agent | Improvement |
| 0.08 | 13.6 | 100 | 99.8 | 33.3 | 39.3 | 18 |
| 0.10 | 11.3 | 100 | 100 | 29.9 | 44.0 | 47 |
| 0.12 | 8.2 | 100 | 99.2 | 34.7 | 52.6 | 52 |

RL agents of the present disclosure may outperform a baseline including a constant action. In some embodiments, the RL agents of the present disclosure outperform the baseline because the RL agents are able to change the parameter T (e.g., dispatching parameter) in response to changing factory conditions. The training and evaluation models include varying processing times and varying numbers of implant recipe groups. The RL agent performs well even when the factory product mix or equipment recipes change. The percentage of lots that process on higher-yield tools and a novel on-time delivery KPI may be used to train and evaluate the agents.

A measure of on-time delivery based on the performance of the equipment group on specified time intervals may be performed and even though the RL agent may be only given a reward at the end of each interval (e.g., the reward is significantly delayed), the agent may still be able to learn to meet the on-time delivery goal. A GNN may be integrated into the PPO RL algorithm. The GNN may allow the RL agent to directly handle different numbers of lots and implant setups. This avoids workarounds like padding that are needed if a MLP network is used directly.

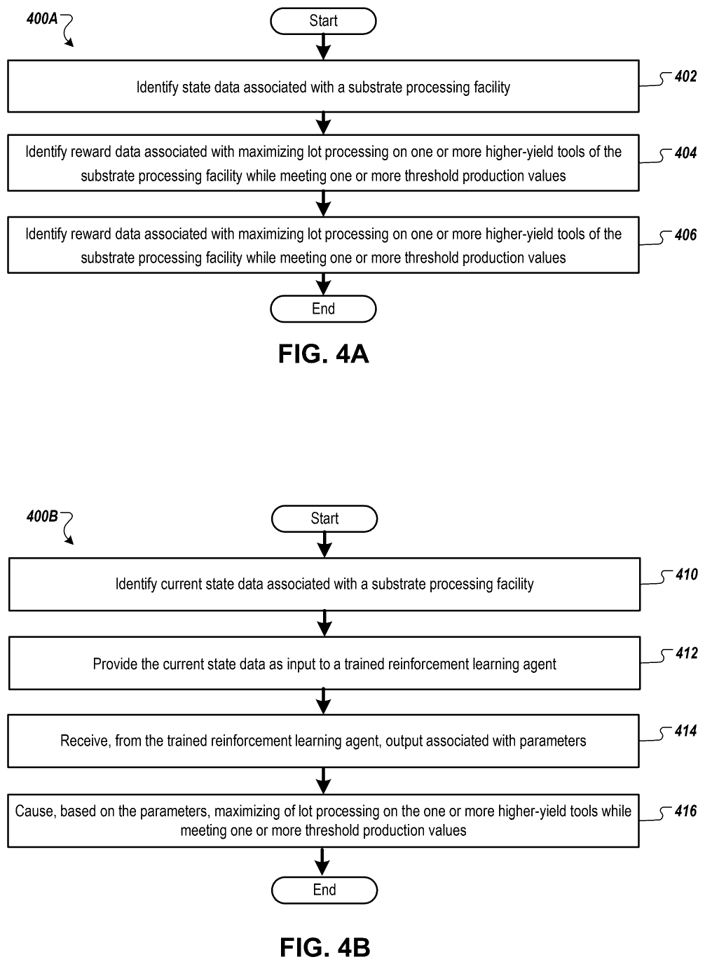

FIGS. 4A-B are flow diagrams of methods 400A-B associated with reinforcement learning for substrate processing facilities (e.g., for yield improvement using dispatching and/or scheduling), according to certain embodiments. In some embodiments, methods 400A-B are performed by processing logic that includes hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, methods 400A-B are performed, at least in part, by server device 110, server machine 180, predictive server 118, and/or client device 114 of FIG. 1. In some embodiments, a non-transitory storage medium stores instructions that when executed by a processing device (e.g., of server device 110, server machine 180, predictive server 118, client device 114, etc.), cause the processing device to perform methods 400A-B.

For simplicity of explanation, methods 400A-B are depicted and described as a series of operations. However, operations in accordance with this disclosure can occur in various orders and/or concurrently and with other operations not presented and described herein. Furthermore, in some embodiments, not all illustrated operations are performed to implement methods 400A-B in accordance with the disclosed subject matter. In addition, those skilled in the art will understand and appreciate that methods 400A-B could alternatively be represented as a series of interrelated states via a state diagram or events.

Referring to FIG. 4A, method 400A is directed to training a reinforcement learning agent.

In some embodiments, at block 402 the processing logic implementing method 400A identifies state data associated with a substrate processing facility (e.g., fab, substrate fabricating facility, factory, etc.). The substrate processing facility includes higher-yield tools and lower-yield tools that have lower yield than the higher yield tools.

In some embodiments, the state data comprises one or more of lot wait data, lot processing data, lot deadline data, tool data, and/or preventative maintenance data for the substrate processing facility.

In some embodiments, the state data includes current state data associated with current processing of current lots in the substrate processing facility. In some embodiments, the state data includes historical state data associated with historical processing of historical lots in the substrate processing facility. In some embodiments, the state data includes perturbed state data formed by one or more of lot duplication, lot removal, or lot location adjustment (e.g., moving lot forward and/or backward) along a route.

At block 404, processing logic identifies reward data associated with maximizing lot processing on the one or more higher-yield tools while meeting one or more threshold production values (e.g., on-time delivery threshold value and/or a production quantity threshold value).

At block 406, processing logic trains a reinforcement learning agent (e.g., RL model, machine learning model) using the state data and the reward data to generate a trained reinforcement learning agent. The trained reinforcement learning agent is to output parameters to maximize the lot processing on the one or more higher-yield tools while meeting the one or more threshold production values (e.g., increase quantity of lots processed by substrate processing equipment that meet a threshold yield and meet threshold time-delivery values).

In some embodiments, the parameters include a maximum waiting lot amount before lot processing via the one or more lower-yield tools. In some embodiments, the parameters include a maximum lot wait time before lot processing via the one or more lower-yield tools. In some embodiments, the parameters include a per-part wait time before lot processing via the one or more lower-yield tools. In some embodiments, the parameters include a per-process wait time before lot processing via the one or more lower-yield tools. In some embodiments, the parameters include a maximum lot wait time for each work-in-progress (WIP) lot.

In some embodiments, to maximize the lot processing on the one or more higher-yield tools while meeting the one or more threshold production values, the parameters are to be provided to one or more of a dispatching system (e.g., to determine and/or implement dispatching decisions) or a scheduling system (e.g., to determine and/or implement scheduling decisions, to generate a schedule, etc.).

In some embodiments, to train the agent (e.g., software agent), processing logic initializes the agent. In some embodiments, the agent can have access to environment state data and/or state data (e.g., data associated with operations related to the fabrication of semiconductor substrates, such as historic state data, current state data, perturbed state data, etc.). The processing logic may perform one or more simulations. The one or more simulations can be performed in a simulation environment (e.g., environment 204 of FIG. 2A). In some embodiments, a simulation can include simulating an action (e.g., one timestep into the future). In some embodiments, processing logic can determine a particular time period the training set of operations are to be run at the substrate processing facility (e.g., fabrication facility). The particular time period can be a simulation condition. In some embodiments, two or more simulations can be run in parallel.

In some embodiments, the simulation can be performed in response to the agent selecting action data. Action data can include a set of possible moves, actions, or operations the software agent can make. In some embodiments, an action can include not releasing a lot, releasing a specific lot, releasing a lot for a specific process chamber, releasing a lot during a certain time period, etc. In some embodiments, the action can include determining a training set of substrates to be processed during a training set of operations. The training set of candidate substrates and the training set of operations be determined using the state data, operator input, a predetermined set of rules (e.g., one or more predetermined sets of substrates, one or more predetermined sets of operations, one or more dispatching parameters, one or more dispatching ranking orders, etc.), random input, or any combination thereof.

In some embodiments, processing logic pauses the simulation to obtain output data. In some embodiments, the output data can include new environment state data and reward data based on the current environment state.

In some embodiments, processing logic updates the agent based on the output data (e.g., new environment state data and new reward data). The new reward data can include feedback data by which the success or failure of an action in a given state is measured.

In some embodiments, processing logic generates, by the agent, a new action (e.g., action data) data based on the new state data.

In some embodiments, processing logic resumes the simulation using the new action data. For example, the processing logic can simulate the new action in the environment.

The processing logic can perform operations (e.g., pausing the simulation to obtain output data, updating the agent using the output data, generating new action data, resuming the simulation using the new action data) until the simulation or the set of simulations is complete. The processing logic can perform method 400A until training the agent is complete. In some embodiments, the output data indicates a number of candidate substrates that were successfully processed during each of the simulated set of operations to reach the end of the time period.

In some embodiments, the sufficiency of training can be determined based simply on the amount of training data or updates to the agent, while in some other embodiments, the sufficiency of training can be determined based on one or more other criteria (e.g., a measure of diversity of the training examples, the reward is achieved by the agent, etc.).

After being trained, the agent can be used to generate predictive data (e.g., parameters, dispatch parameters, ranking orders, dispatching decisions, scheduling parameters, decisions, etc.) based on current state data. In some embodiments, the predictive data can include one or more parameters (e.g., dispatch parameters and/or one or more dispatch ranking orders). For example, the machine-learning model can receive, as input, current state data and output the one or more parameters (e.g., dispatch parameters and/or one or more dispatch ranking orders). A dispatching decision and/or scheduling decision may indicate what action should be performed at a given time in the production environment and can be based on one or more parameters (e.g., dispatch parameters and/or one or more dispatch ranking orders). Dispatching and/or scheduling decisions can include where a substrate or lot should be processed next in the production environment, which substrate or lot should be picked for an idle piece of equipment in the production environment, whether to start processing a lot that has fewer substrates than allowed, whether to wait to start the lot until additional substrates are available so a full lot can be started, etc.

Referring to FIG. 4B, method 400B is directed to using a reinforcement learning agent.

In some embodiments, at block 410 the processing logic implementing method 400B identifies current state data associated with a substrate processing facility. The substrate processing facility includes higher-yield tools and lower-yield tools that have a lower yield than the higher-yield tools.

In some embodiments, the current state data relates to the current state of substrate processing facility. In some embodiments, the current state data can include sensor data, contextual data, task data, etc. In some embodiments, the current state data can include a number of substrates (e.g., substrate lots) being processed at the manufacturing equipment at a particular instance of time, a number of substrates (e.g., substrate lots) in a manufacturing equipment queue, current service life, setup data, a set of operations that include individual processes performed at one or more manufacturing facilities of a production environment, etc. In some embodiments, the current state data can relate to one or more operations being performed on one or more substrates (e.g., substrate lots) being processed. For example, the operation can include a deposition process performed in a process chamber to deposit one or more layers of film on a surface of a substrate, an etch process performed on the one or more layers of film on the surface of the substrate, etc. The operation can be performed according to a recipe. The sensor data can include a value of one or more of temperature (e.g., heater temperature), spacing, pressure, high frequency radio frequency, voltage of electrostatic chuck, electrical current, material flow, power, voltage, etc. Sensor data can be associated with or indicative of manufacturing parameters such as hardware parameters, such as settings or components (e.g., size, type, etc.) of the manufacturing equipment 112, or process parameters of the manufacturing equipment 112.

At block 412, processing logic provides the current state data as input to a trained reinforcement learning agent (e.g., agent execution 246 of FIG. 2B). In some embodiments, the processing logic applies the agent (e.g., software agent, agent 190 of FIG. 1, agent 202 of FIGS. 2A and/or 2B) to the obtained current state data.

At block 414, processing logic receives, from the trained reinforcement learning agent, output associated with parameters.

The agent can be used to generate predictive data (e.g., output) that is associated includes one or more dispatching and/or scheduling settings (e.g., values, criterion, rankings, etc.) of one or more dispatching and/or scheduling factors (e.g., parameters 156 of FIG. 1, dispatching parameters, dispatching ranking orders). In some embodiments, the output can be associated with (e.g., include) one or more dispatching and/or scheduling decisions. In some embodiments, the agent can generate a set of parameters (e.g., parameters 156 of FIG. 1, dispatching parameters, dispatching ranking orders). In some embodiments, to generate the predictive data, the software agent can modify one or more existing parameters (e.g., parameters 156 of FIG. 1, dispatching parameters, dispatching ranking orders).At block 416, processing logic causes, based on the parameters, maximizing of lot processing on the one or more higher-yield tools while meeting one or more threshold production values.

In some embodiments, the processing logic generates a dispatching and/or scheduling decision based on the output from the agent. For example, the processing logic can generate a dispatching and/or scheduling decision based on the dispatching and/or scheduling settings (e.g., values criterion, or rankings) for parameters (e.g., parameters, dispatching parameters, dispatching rankings) associated with the output of the training reinforcement learning agent. In some embodiments, the decision can be indicative of what action should be performed at a given time in the production environment. In some embodiments, the decision can include a candidate set of substrates and a specified time period. In some embodiments, the processing logic can generate decisions, based on the output of the trained reinforcement learning agent, until a new trigger condition is detected. For example, if the trigger condition is a time period (e.g., 30 minutes), then the processing logic can generate decisions based on the output for thirty minutes, until the time period lapses, and new current data is obtained.

In some embodiments, the processing logic initiates the set of operations at the substrate processing facility to process a candidate set of substrates (e.g., substrate lot) based on the decision.

In some embodiments (e.g., prior to block 410 of FIG. 4B), the processing logic detects a trigger condition at a substrate processing facility. The trigger condition can include a factory event, a time period lapsing, a user request, a user-specified trigger, or any other type of trigger event. A factory event can include any event affecting a condition or parameter of manufacturing equipment 112. For example, a factory event can include at a component of manufacturing equipment 112 (e.g., a process chamber, a robot, a load port, etc.) becoming operational, a component shutting down, a new component installed, a component being decommissioned, a new product being introduced, a new recipe being introduced, an operational parameter being adjusted, preventative maintenance being performed, etc. A time period lapsing can include a timer expiring, a scheduled time occurring, etc. For example, it may be desirable to apply the reinforcement learning agent every thirty minutes such that all decisions (e.g., dispatching decisions, scheduling decisions) during the subsequent thirty minutes use the same parameters (e.g., dispatching parameters and/or dispatching rankings). As such, the trigger condition can include a time period of thirty minutes, where every thirty minutes the reinforcement learning agent is applied to current state data, as described herein. In some embodiments, the processing logic can receive a request (e.g., a user request, a predetermined or previously set request, an automatic request, etc.) to initiate a set of operations to be run at the production environment. In some embodiments, the request can be a request to initiate the set of operations to be run at the processing system at a particular instance in time. For example, the request can be a request to initiate the set of operations at 8:00 μm. In some embodiments, the request can be a request to initiate the set of operations on a candidate set of substrates (e.g., substrates lot). In some embodiments, the request can be a request for a decision (e.g., dispatching decision, scheduling decision) relating to the candidate set of substrates. For example, the request can be for a next available time to initiate the set of operations on the candidate set of substrates where no time constraint issues are to occur. A user-specified trigger can include any criterion that, once satisfied, triggers the trigger condition (e.g., sensing a certain time, a certain sensor parameter, etc.).

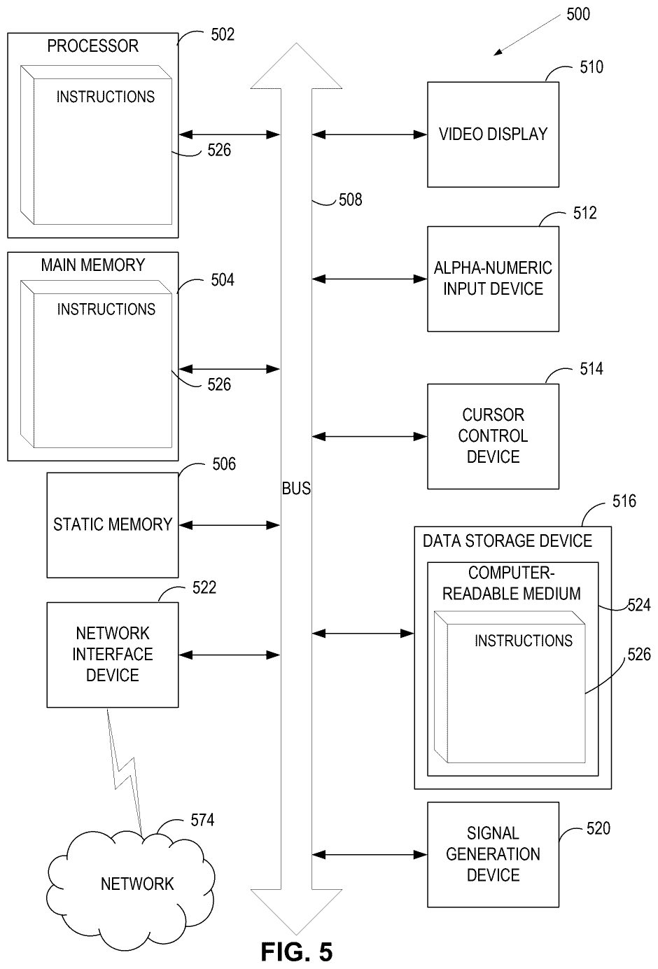

FIG. 5 is a block diagram illustrating a computer system 500, according to certain embodiments. In some embodiments, the computer system 500 is one or more of client device (e.g., client device 114 of FIG. 1) or server device (e.g., server device 110 of FIG. 1, server machine 180 of FIG. 1, predictive server 118 of FIG. 1, etc.).

In some embodiments, computer system 500 is connected (e.g., via a network, such as a Local Area Network (LAN), an intranet, an extranet, or the Internet) to other computer systems. In some embodiments, computer system 500 operates in the capacity of a server or a client computer in a client-server environment, or as a peer computer in a peer-to-peer or distributed network environment. In some embodiments, computer system 500 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 includes a processing device 502, a volatile memory 504 (e.g., Random Access Memory (RAM)), a non-volatile memory 506 (e.g., Read-Only Memory (ROM) or Electrically-Erasable Programmable ROM (EEPROM)), and a data storage device 516, which communicate with each other via a bus 508.

In some embodiments, processing device 502 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 500 further includes a network interface device 522 (e.g., coupled to network 574). In some embodiments, computer system 500 also includes a video display unit 510 (e.g., a liquid crystal display (LCD)), an alphanumeric input device 512 (e.g., a keyboard), a cursor control device 514 (e.g., a mouse), and a signal generation device 520.

In some embodiments, data storage device 516 includes a non-transitory computer-readable storage medium 524 on which store instructions 526 encoding any one or more of the methods or functions described herein, including instructions encoding components (e.g., of one or more of FIGS. 1-2D) and for implementing methods described herein.

In some embodiments, instructions 526 also reside, completely or partially, within volatile memory 504 and/or within processing device 502 during execution thereof by computer system 500, hence, in some embodiments, volatile memory 504 and processing device 502 also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In some embodiments, the methods, components, and features described herein are implemented by discrete hardware components or are integrated in the functionality of other hardware components such as application-specific integrated circuits (ASICs), field programmable gate arrays (FPGAs), digital signal processors (DSPs), or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “causing,” “determining,” “running,” “continuing,” “interrupting,” “initiating,” “identifying,” “training,” “providing,” “obtaining,” “outputting,” “predicting,” “receiving,” “updating,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or includes a general-purpose computer system selectively programmed by a computer program stored in the computer system. Such a computer program is stored in a computer-readable tangible storage medium.

The methods and illustrative examples described herein are not inherently related to any particular computer or other apparatus. In some embodiments, various general-purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

1. A method comprising:
identifying current state data associated with a substrate processing facility comprising one or more higher-yield tools and one or more lower-yield tools that have a lower yield than the one or more higher-yield tools;
providing the current state data as input to a trained reinforcement learning agent;
receiving, from the trained reinforcement learning agent, output associated with parameters; and
causing, based on the parameters, maximizing of lot processing on the one or more higher-yield tools while meeting one or more threshold production values.

2. The method of claim 1, the trained reinforcement learning agent being trained using the state data and reward data, the reward data being associated with the maximizing of the lot processing on the one or more higher-yield tools while meeting the one or more threshold production values.

3. The method of claim 1, wherein the one or more threshold production values comprise an on-time delivery threshold value or a production quantity threshold value.

4. The method of claim 1, wherein the parameters comprise one or more of:
a maximum waiting lot amount before lot processing via the one or more lower-yield tools;
a maximum lot wait time before lot processing via the one or more lower-yield tools;
per-part wait time before lot processing via the one or more lower-yield tools;
per-process wait time before lot processing via the one or more lower-yield tools; or
maximum lot wait time for each work-in-progress lot.

5. The method of claim 1, wherein the state data comprises one or more of lot wait data, lot processing data, lot deadline data, tool data, or preventative maintenance data.

6. The method of claim 1, wherein the parameters are associated with one or more of dispatching decisions or scheduling decisions.

7. The method of claim 1, wherein the causing of the maximizing of the lot processing on the one or more higher-yield tools while meeting the one or more threshold production values comprises providing the parameters to one or more of a dispatching system or a scheduling system.

8. A method comprising:
identifying state data associated with a substrate processing facility comprising one or more higher-yield tools and one or more lower-yield tools that have a lower yield than the one or more higher-yield tools;
identifying reward data associated with maximizing lot processing on the one or more higher-yield tools while meeting one or more threshold production values; and
training a reinforcement learning agent using the state data and the reward data to generate a trained reinforcement learning agent, wherein the trained reinforcement learning agent is to output parameters to maximize the lot processing on the one or more higher-yield tools while meeting the one or more threshold production values.

9. The method of claim 8, wherein the one or more threshold production values comprise an on-time delivery threshold value or a production quantity threshold value.

10. The method of claim 8, wherein the parameters comprise one or more of:
a maximum waiting lot amount before lot processing via the one or more lower-yield tools;
a maximum lot wait time before lot processing via the one or more lower-yield tools;
per-part wait time before lot processing via the one or more lower-yield tools;
per-process wait time before lot processing via the one or more lower-yield tools; or
maximum lot wait time for each work-in-progress lot.

11. The method of claim 8, wherein the state data comprises one or more of lot wait data, lot processing data, lot deadline data, tool data, or preventative maintenance data.

12. The method of claim 8, wherein to maximize the lot processing on the one or more higher-yield tools while meeting the one or more threshold production values, the parameters are to be provided to one or more of a dispatching system or a scheduling system.

13. The method of claim 8, wherein the state data comprises one or more of:
current state data associated with current processing of current lots in the substrate processing facility; or
historical state data associated with historical processing of historical lots in the substrate processing facility.

14. The method of claim 8, wherein the state data comprises perturbed state data formed by one or more of lot duplication, lot removal, or lot location adjustment along a route.

15. A non-transitory computer readable medium having instructions stored thereon, which, when executed by a processing device, cause the processing device perform operations comprising:
identifying current state data associated with a substrate processing facility comprising one or more higher-yield tools and one or more lower-yield tools that have a lower yield than the one or more higher-yield tools;
providing the current state data as input to a trained reinforcement learning agent;
receiving, from the trained reinforcement learning agent, output associated with parameters; and
causing, based on the parameters, maximizing of lot processing on the one or more higher-yield tools while meeting one or more threshold production values.

16. The non-transitory computer readable medium of claim 15, the trained reinforcement learning agent being trained using the state data and reward data, the reward data being associated with the maximizing of the lot processing on the one or more higher-yield tools while meeting the one or more threshold production values.

17. The non-transitory computer readable medium of claim 15, wherein the one or more threshold production values comprise an on-time delivery threshold value or a production quantity threshold value.

18. The non-transitory computer readable medium of claim 15, wherein the parameters comprise one or more of:
a maximum waiting lot amount before lot processing via the one or more lower-yield tools;
a maximum lot wait time before lot processing via the one or more lower-yield tools;
per-part wait time before lot processing via the one or more lower-yield tools;
per-process wait time before lot processing via the one or more lower-yield tools; or
maximum lot wait time for each work-in-progress lot.

19. The non-transitory computer readable medium of claim 15, wherein the state data comprises one or more of lot wait data, lot processing data, lot deadline data, tool data, or preventative maintenance data.

20. The non-transitory computer readable medium of claim 15, wherein one or more of:
the parameters are associated with one or more of dispatching decisions or scheduling decisions; or
the causing of the maximizing of the lot processing on the one or more higher-yield tools while meeting the one or more threshold production values comprises providing the parameters to one or more of a dispatching system or a scheduling system.
